(19) United States
(12) Patent Application Publication
(10) Pub. No.: US 2017/0364849 A1
(43) Pub. Date: Dec. 21, 2017

(54) SOFTWARE-BASED ERM WATCHTOWER FOR AGGREGATING RISK DATA, CALCULATING WEIGHTED RISK PROFILES, REPORTING, AND MANAGING RISK

(71) Applicant: Strategic Risk Associates, Richmond, VA (US)

(72) Inventors: Michael Glotz, Glen Allen, VA (US); Albert Knotts, Alexandria, VA (US); Rob Mitchell, Richmond, VA (US); Stephen Lane, Fairfax, VA (US)

(73) Assignee: Strategic Risk Associates, Richmond, VA (US)

(21) Appl. No.: 15/624,204

(22) Filed: Jun. 15, 2017

Related U.S. Application Data
(60) Provisional application No. 62/350,249, filed on Jun. 15, 2016.

(51) Int. Cl. G06Q 10/06; G06Q 30/00; G06Q 40/02; G06Q 50/18

(52) U.S. Cl. CPC G06Q 10/0635; G06Q 50/18; G06Q 30/018; G06Q 40/025

(57) ABSTRACT

A software tool may analyze the constantly evolving and increasing velocity of enterprise risk, aggregates organizational risk, creates risk profiles at each level of the organization, and provides a central risk management hub that uses novel risk management algorithms to aggregate and provide risk management information to users. In order to quantitatively determine risk, calculations may be performed in a hierarchical manner. A risk category may include an inherent risk component and a quality of risk management component. Ratings for a given risk category may be derived from a sum of weighted rankings of each risk component thereof. Ratings for each risk component may be derived from its risk attributes.

### CROSS-REFERENCE TO RELATED APPLICATIONS

This application claims the benefit of U.S. Provisional Patent Application No. 62/350,249 filed Jun. 15, 2016. The subject matter of this earlier filed application is hereby incorporated by reference in its entirety.

### FIELD

The present invention generally pertains to risk management, and more specifically, to a software tool that analyzes the constantly evolving and increasing velocity of enterprise risk, aggregates organizational risk, and provides a central risk management hub that uses novel risk management metrics to aggregate and provide risk management information to users.

### BACKGROUND

After the 2008-2009 economic recession, it became evident that financial services companies have done a less than acceptable job of identifying and managing their prevailing enterprise risks. As a result, strengthened regulatory scrutiny and regulatory prerequisites became the norm. Efforts have been focused on developing clients' capabilities in enterprise risk management (ERM) and capital planning. Most ERM and capital planning guidance has been implemented through the manual creation of risk models and reporting formats in Excel® spreadsheets.

However, this is not only time-consuming from a computer processing standpoint, but also lacks flexibility and the use of recurring processes and protocols. For instance, Excel® solutions lack cross-function/department responsibility, have poor reporting capabilities, require manual aggregation of a variety of data sources (which is slow and expensive) and do not match auditors' requirements/viewpoints. These Excel® processes and protocols were also inadequate for enterprises in view of the constantly evolving and increasing velocity of enterprise risk. Such processes should be further defined and developed, made simpler and more effective, and be more flexible with a consolidated, easy-to-use technology solution that provides better aggregation and coordination, greater consistency, and increased transparency and ease of use. Such a solution should have also provided a real-time and transparent way of aggregating, managing, and reporting risks across the entire spectrum of an enterprise. Thus, an improved ERM solution may be beneficial.

### SUMMARY

Certain embodiments of the present invention may provide solutions to the problems and needs in the art that have not yet been fully identified, appreciated, or solved by conventional risk management technologies. For example, some embodiments of the present invention pertain to a software tool that analyzes the constantly evolving and increasing velocity of enterprise risk, aggregates organizational risk, creates risk profiles at each level of the organization, and provides a central risk management hub that uses novel risk management algorithms to aggregate and provide risk management information to users.

In an embodiment, a computer program is embodied on a non-transitory computer-readable medium. The program is configured to cause at least one processor to determine a weighted inherent risk rating for a risk category from a plurality of weighted inherent risk attribute and Key Risk Indicator (KRI) ratings and determine a weighted quality of risk management rating for the risk category from a plurality of weighted quality of risk management attribute ratings. The program is also configured to cause the at least one processor to add the weighted inherent risk rating and the weighted quality of risk management rating to yield a composite risk rating for the risk category and display the composite risk rating for the risk category on a display device.

In another embodiment, a computer-implemented method includes determining, by a computing system, inherent risk ratings and quality of risk management ratings for a plurality of risk categories for a time period. The computer-implemented method also includes applying weights, by the computing system, to each of the inherent risk category rating and each of the quality of risk management category rating. The computer-implemented method further includes adding the weighted inherent risk category ratings, by the computing system, to yield a composite inherent risk rating and adding the weighted quality of risk management category ratings, by the computing system, to yield a composite quality of risk management rating. Additionally, the computer-implemented method includes displaying, by the computing system, the composite inherent risk rating and the composite quality of risk management rating on a display device. In some embodiments, several composite entity ratings may be aggregated and weighted based on their significance to develop an overall enterprise-wide rating made up of various entities in an organization.

In yet another embodiment, a computer-implemented method includes determining, by a computing system, inherent risk ratings and quality of risk management ratings for a plurality of risk categories for a current time period and applying weights, by the computing system, to each inherent risk category rating and each quality of risk management category rating. The computer-implemented method also includes adding the weighted inherent risk category ratings, by the computing system, to yield a composite inherent risk rating for the current time period and adding the weighted quality of risk management category ratings, by the computing system, to yield a composite quality of risk management rating for the current time period. The computer-implemented method further includes averaging, by the computing system, the composite inherent risk rating and the composite quality of risk management rating for the current time period with composite inherent risk ratings and composite quality of risk management ratings from a plurality of previous time periods, respectively, to yield an averaged inherent risk rating and an averaged composite quality of risk management rating. Additionally, the computer-implemented method includes displaying, by the computing system, the averaged inherent risk rating and an averaged composite quality of risk management rating on a display device.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating a system configured to implement an ERM watchtower application, according to an embodiment of the present invention.

FIG. 2 is an architectural diagram illustrating a network system including an ERM watchtower application server and other external servers from which data may be received, according to an embodiment of the present invention.

FIG. 3 illustrates organizational inputs to an ERM watchtower application, according to an embodiment of the present invention.

FIG. 4 is a screenshot illustrating general enterprise-wide risk view interface during a time period, according to an embodiment of the present invention.

FIG. 5A is a screenshot illustrating an interface for creating a new risk category, according to an embodiment of the present invention.

FIG. 5B is a screenshot illustrating an interface for editing an existing risk category, according to an embodiment of the present invention.

FIG. 6 is a screenshot illustrating a risk category selection interface, according to an embodiment of the present invention.

FIG. 7 is a screenshot illustrating a previous time period selection interface for applying defaults to a category, according to an embodiment of the present invention.

FIG. 8 is a screenshot illustrating an inherent risk setup interface, according to an embodiment of the present invention.

FIG. 9 is a screenshot illustrating a quality of risk management setup interface, according to an embodiment of the present invention.

FIG. 10 is a screenshot illustrating a risk component weights setup interface, according to an embodiment of the present invention.

FIG. 11 is a screenshot illustrating a risk owners setup interface, according to an embodiment of the present invention.

FIG. 12 is a screenshot illustrating a risk appetite statement interface, according to an embodiment of the present invention.

FIG. 13 is a screenshot illustrating a risk category setup completion interface, according to an embodiment of the present invention.

FIG. 14 is a screenshot illustrating an initial setup interface for assessing attributes, according to an embodiment of the present invention.

FIG. 15 is a screenshot illustrating an assess attributes confirmation interface, according to an embodiment of the present invention.

FIG. 16 is a screenshot illustrating an assess attributes interface with clickable risk attributes, according to an embodiment of the present invention.

FIG. 17 is a screenshot illustrating an attribute view interface, according to an embodiment of the present invention.

FIG. 18 is a screenshot illustrating an edit attribute interface, according to an embodiment of the present invention.

FIG. 19 is a screenshot illustrating a first portion of a risk improvement activity creation interface, according to an embodiment of the present invention.

FIG. 20 is a screenshot illustrating a second portion of a risk improvement activity creation interface, according to an embodiment of the present invention.

FIG. 21 is a screenshot illustrating a third portion of a risk improvement activity creation interface, according to an embodiment of the present invention.

FIG. 22 is a screenshot illustrating a first portion of a top risk interface, according to an embodiment of the present invention.

FIG. 23 is a screenshot illustrating a second portion of a top risk interface, according to an embodiment of the present invention.

FIG. 24 is a screenshot illustrating a third portion of a top risk interface, according to an embodiment of the present invention.

FIG. 25 is a screenshot illustrating a, ERM watchtower enterprise-wide risk aggregation dashboard, according to an embodiment of the present invention.

FIG. 26 is a screenshot illustrating a detailed breakdown of risk levels for each attribute for the credit category, according to an embodiment of the present invention.

FIG. 27 is a screenshot illustrating a manual rating input interface, according to an embodiment of the present invention.

FIG. 28 is a screenshot illustrating a risk attribute interface with risk attribute indicators, according to an embodiment of the present invention.

FIG. 29 is a screenshot illustrating a risk attribute indicator interface, according to an embodiment of the present invention.

FIG. 30 is a screenshot illustrating a risk attribute interface with selectable risk attribute indicators, according to an embodiment of the present invention.

FIG. 31 is a screenshot illustrating a self-assessment consideration rating interface, according to an embodiment of the present invention.

FIG. 32 is a screenshot illustrating risk attributes for quality of risk management, according to an embodiment of the present invention.

FIG. 33 is a screenshot illustrating risk attributes for inherent risk, according to an embodiment of the present invention.

FIG. 34 is a screenshot illustrating risk categories and composite risk ratings, according to an embodiment of the present invention.

FIG. 35 is a screenshot illustrating a time period risk weights editing interface, according to an embodiment of the present invention.

FIG. 36 is a flowchart illustrating a process for calculating enterprise-wide risk, according to an embodiment of the present invention.

FIG. 37 is a block diagram of a computing system configured to implement an ERM watchtower application, according to an embodiment of the present invention.

### DETAILED DESCRIPTION OF THE EMBODIMENTS

Some embodiments of the present invention pertain to a software tool that analyzes the constantly evolving and increasing velocity of enterprise risk, aggregates organizational risk, creates risk profiles at each level of the organization, and provides a central risk management hub that uses novel risk management algorithms to aggregate and provide risk management information to users. In order to quantitatively determine risk, calculations may be performed in a hierarchical manner. A risk category may include an inherent risk component and a quality of risk management component. Ratings for a given risk category may be derived from a sum of weighted rankings of each risk component thereof. Ratings for each risk component may be derived from its risk attributes.

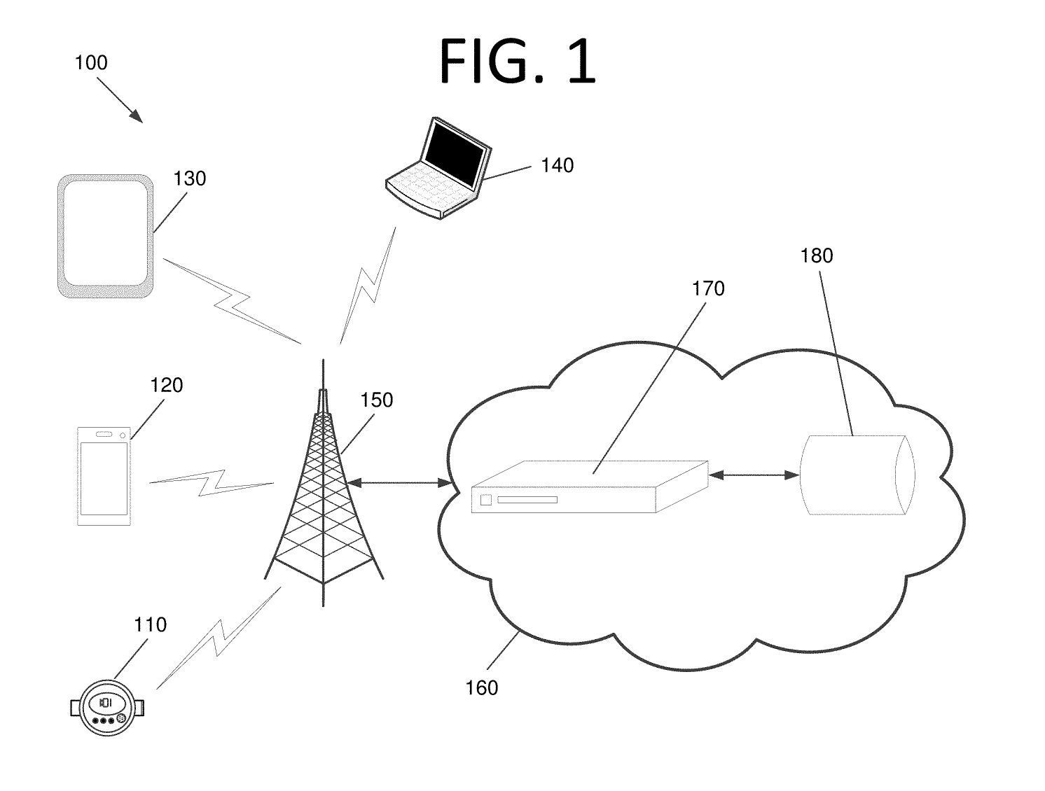

FIG. 1 is an architectural diagram illustrating a system 100 configured to implement an ERM watchtower, according to an embodiment of the present invention. System 100 includes a smart watch 110, a mobile phone 120, a tablet computer 130, a laptop computer 140, a base station 150, the Internet 160, and a server 170. While the communications here are shown as wireless, in some embodiments, wired communications may also be used for one or more of the communication links. Also, Ethernet, Wi-Fi, Bluetooth™, cable, any other suitable communications technology, or any combination thereof, may be used without deviating from the scope of the invention. Indeed, any local area network (LAN), wide area network (WAN), or Internet technology may be used supplemental to, or in place of, the network depicted herein.

Users of smart watch 110, mobile phone 120, tablet computer 130, and laptop computer 140 use an ERM watchtower client application or a web browser running thereon. The ERM watchtower application or website may be custom-tailored for the specific hardware capabilities, display constraints, etc. of each device. In FIG. 1, smart watch 110, mobile phone 120, tablet computer 130, and laptop computer 140 communicate with the Internet 160 via base station 150. Base station 150 communicates with the Internet 160 via a telecommunications network, which may be any suitable telecommunications network, such as those of any currently available commercial carrier or combination of carriers. The telecommunications network may utilize any suitable standards and technologies, such as enhanced Node Bs, Radio Network Controllers (RNCs), 3G, 4G, 5G, etc. For the sake of convenience, the details of the telecommunications network are not shown, and the details of the Internet 160 are abstracted here, but may have any desired architecture without deviating from the scope of the invention.

Within or otherwise accessible by Internet 160 is a server 170 that runs a server-side implementation of the ERM watchtower application. For instance, the server-side ERM watchtower application may gather pertinent risk information from various sources, perform various risk calculations, and store/update the information in a database 180. The server-side ERM watchtower application may gather data periodically and send updates to smart watch 110, mobile phone 120, tablet computer 130, and laptop computer 140 in some embodiments. The server-side ERM watchtower application may also push communications out to client-side ERM watchtower applications in some embodiments.

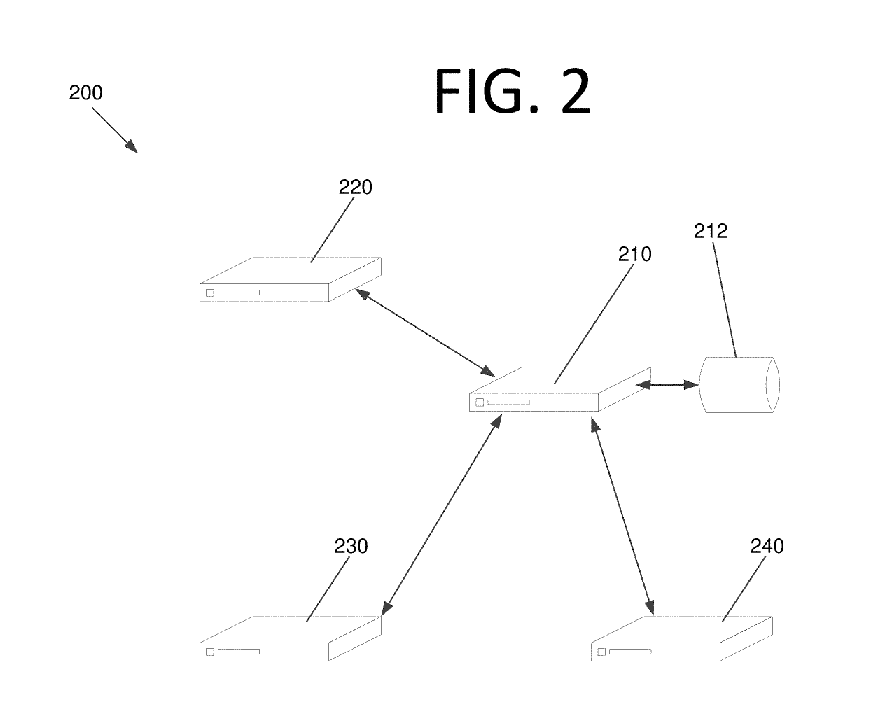

FIG. 2 is an architectural diagram illustrating a network system 200 including an ERM watchtower application server 210 and other external servers from which data may be received, according to an embodiment of the present invention. Here, ERM watchtower server 210 receives information from a banking server 220 (e.g., strategic, reputational, credit, market, liquidity, compliance, operational, pricing, legal, and cybersecurity information). ERM watchtower server 210 also receives information from a realty server 230 (e.g., strategic, credit, compliance, and operational information), as well as from an insurance server (e.g., strategic, compliance, and operational information). This information is then stored in database 212 and used to update risk calculations. These servers are provided by business line in this embodiment. However, in some embodiments, all information is received, aggregated, calculated, and provided by ERM watchtower server 210. Furthermore, in some embodiments, this information may be distributed across any number of servers in a cloud and/or distributed computing environment without deviating from the scope of the invention.

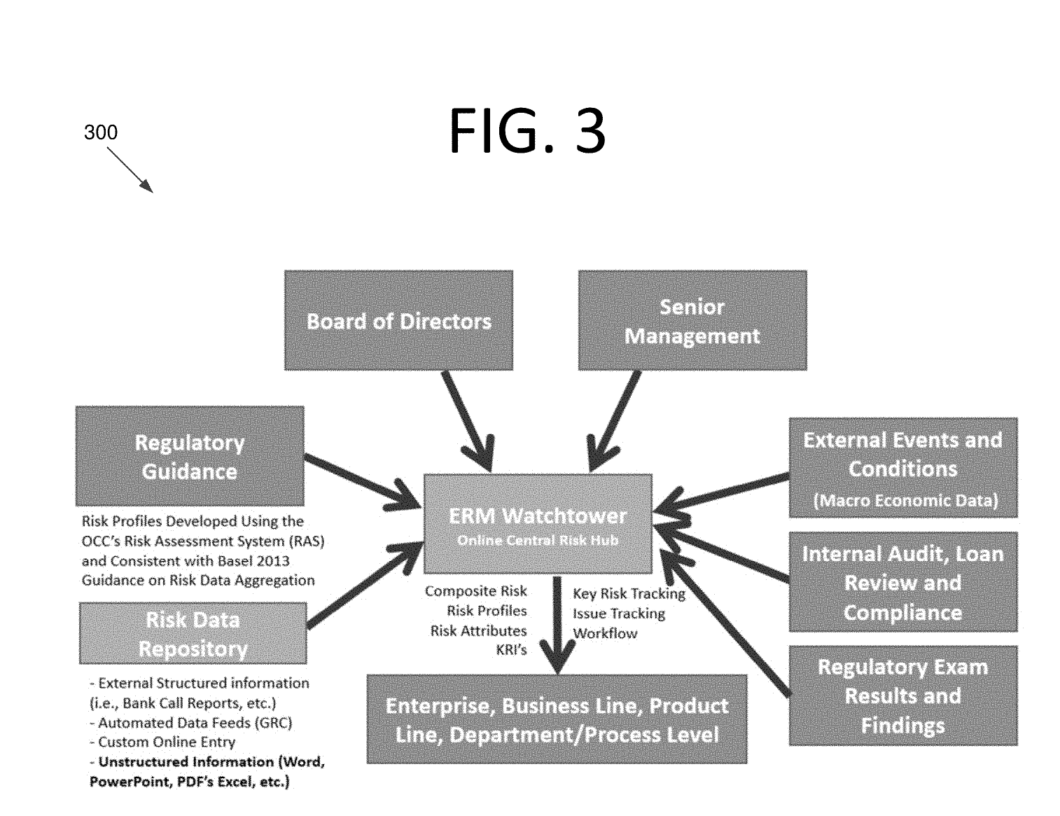

FIG. 3 illustrates organizational inputs 300 to an ERM watchtower, according to an embodiment of the present invention. The ERM watchtower serves as an online central risk hub that receives input from the board of directors and senior management. The ERM watchtower also receives macroeconomic data measuring external events and conditions, internal audit issues and findings, loan review results, compliance issues and risk assessments, regulatory exam results and findings, regulatory guidance, and data from a risk data repository. The data from the risk repository may include all available risk assessment data from across the company (including various documents in Microsoft Word®, Excel®, PowerPoint®, and PDF), Key Risk Indicators (KRIs), Key Performance Indicators (KPIs), financial information, capital strategic information, and other resultant data that each organization may find valuable to assess risk. With respect to regulatory guidance, risk profiles may be developed using the Risk Assessment System (RAS) from the Office of the Comptroller of the Currency (OCC) and other federal regulators, and may be consistent with Basel 2013 (BCBS 239) guidance on risk data aggregation. The risk data repository may include external structured information (e.g., bank call reports from over 10,000 U.S. banks and credit unions, etc.), automated data feeds (e.g., Governance, Risk, and Compliance (GRC)), custom online entries of key risk data related to credit risk, interest rate risk, liquidity risk, pricing risk, strategic risk, operational risk, information technology (IT) risk, cybersecurity risk, compliance risk, legal risk, insurance risk, reputational risk, and human capital risk, and unstructured information (such as that saved in Microsoft Word®, PowerPoint®, Excel®, PDFs, etc.

The ERM watchtower may process this information and determine composite risk ratings, risk profiles, risk attributes, risk trends, unique KRIs and/or KPIs, etc. The ERM watchtower may also provide key risk tracking, issue tracking, workflow, document storage, etc. This information may be provided at the enterprise level, business line level, product line level, department/process level, etc.

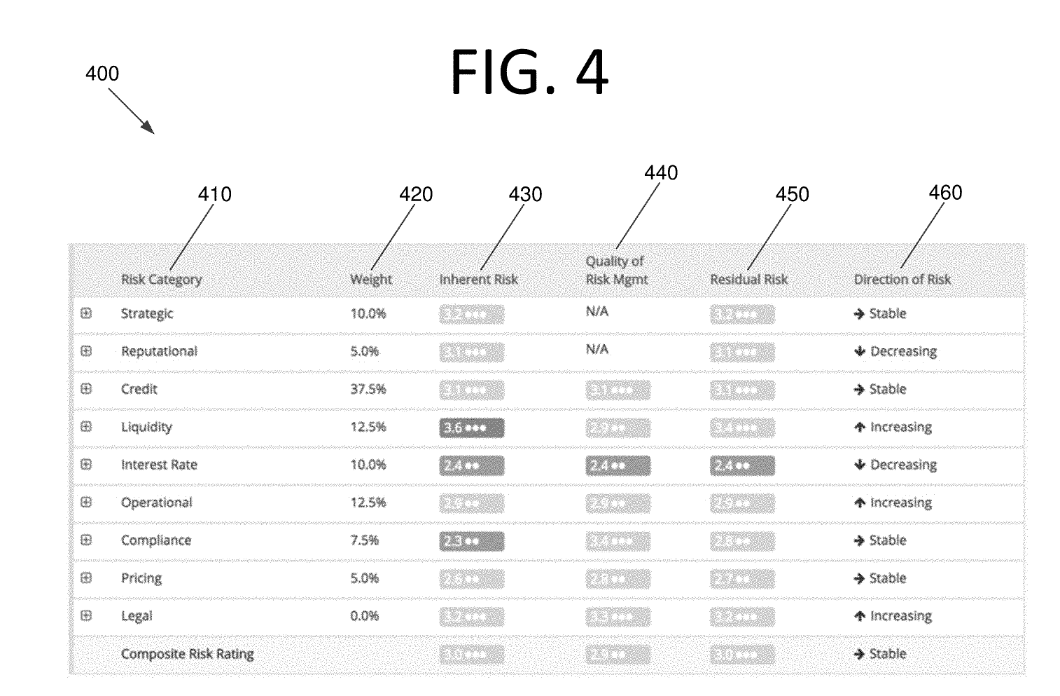

The ERM watchtower of some embodiments may provide a centralized and standardized view of enterprise-wide risk, such a credit risk, market risk, liquidity risk, operational risk, etc. A general enterprise-wide risk view during a time period is provided in screenshot 400 of FIG. 4. In this view, clickable risk categories 410 enable the user to drill down and see further information for how risk was calculated for that specific category. A weight 420 assigned to each risk category is also included, as well as inherent risk 430, quality of risk management 440, and residual risk 450. The direction of risk 460 indicates whether the risk level for the given category is increasing, stable, or decreasing during the current time period as opposed to one or more previous time periods.

ERM is a holistic and comprehensive framework to managing risk. A multi-stage systemic and strategic approach to delivering advanced enterprise risk aggregation and reporting tools may be employed and supplemented with the ERM watchtower. For instance, a four-stage process may be employed that includes: (1) risk governance; (2) risk profile (ERM watchtower); (3) capital planning and adequacy; and (4) integrating loan review and audit planning and reporting. The risk profile stage may include, but is not limited to: (1) generating risk profiles and composite risk ratings (e.g., strategic, interest rate risk, liquidity, price, credit, operational, compliance, cybersecurity, etc.); (2) performing scheduled ERM review, update, and monitoring routines; (3) identifying key risks, direction of risk metrics, risk trends, and reporting (e.g., by risk category and bank-wide); (4) identifying risk improvement program, KRIs, and risk control self-assessments (RCSAs) (by executive and department); and (5) redesigning ERM reporting and efficient delivery (by risk category, business line, and department.

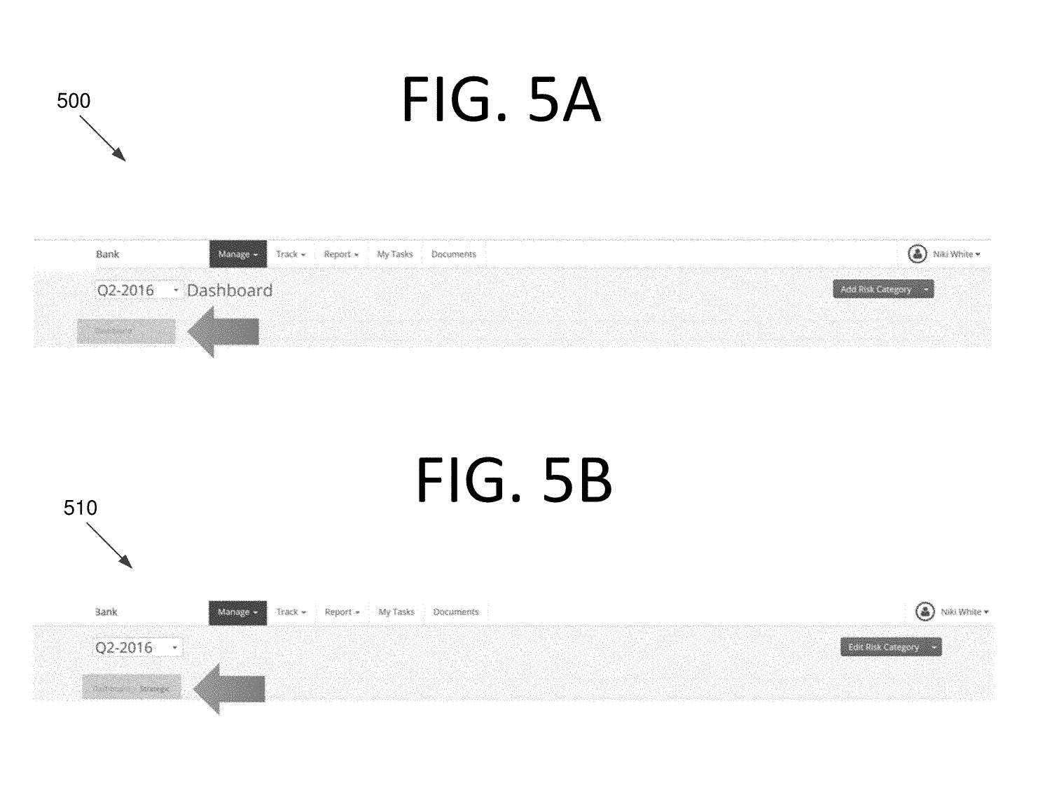

In some embodiments, risk categories may first need to be created. For instance, a user may create a new risk category as shown in screenshot 500 of FIG. 5A. Once created, the user may edit the risk category, as shown in screenshot 510 of FIG. 5B.

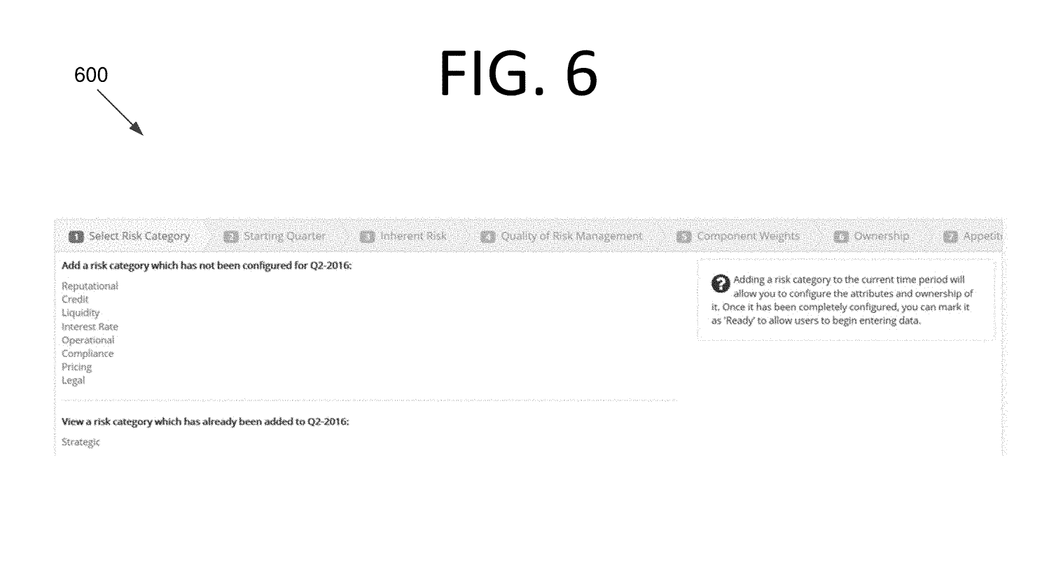

Once the risk categories have been setup, the risk models for each category may be established. A user may select a risk category for configuration, as shown in screenshot 600 of FIG. 6. This interface shows the option to add risk categories that have not been configured for a given time period (here, the second quarter of 2016), as well as risk categories that have already been added for the time period.

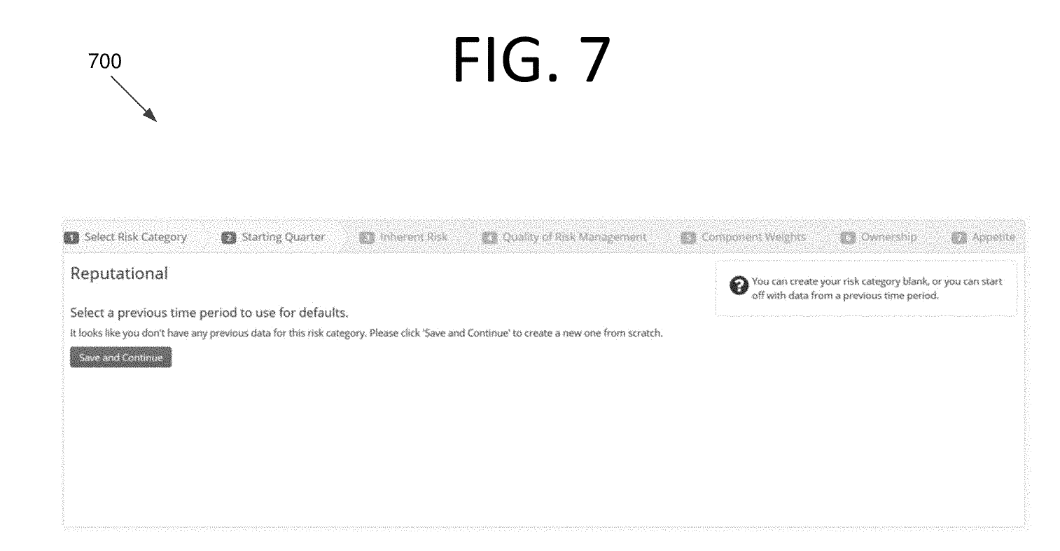

Once a user selects a category to add and configure, the user may select a previous time period to use for defaults. For instance, in screenshot 700 of FIG. 7, the user has selected the reputational category, but there is no previous category data. However, if such data were present, it would be displayed for selection.

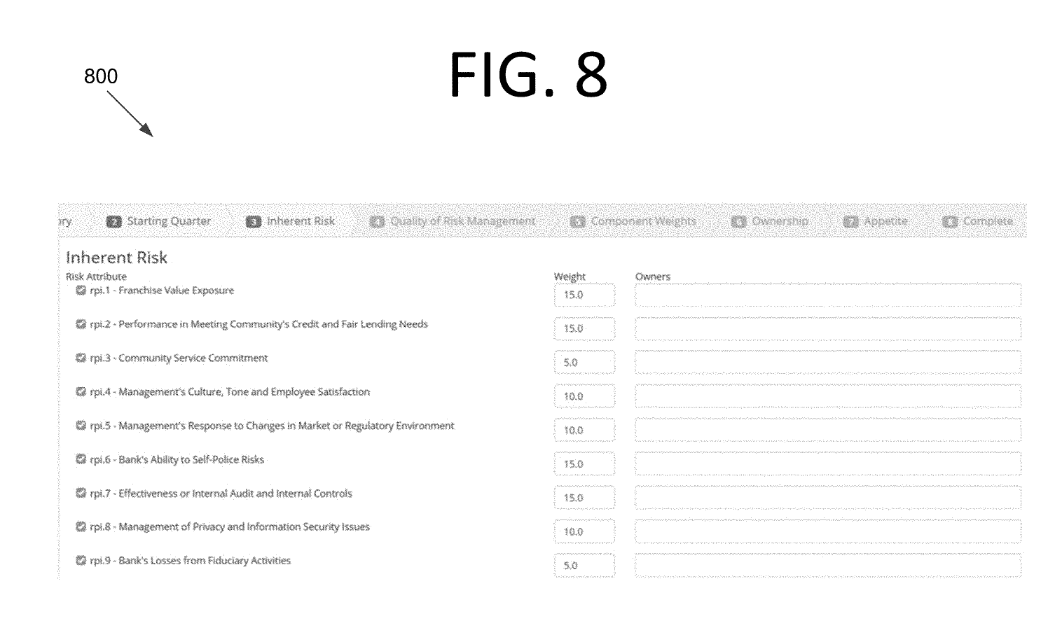

FIG. 8 is a screenshot 800 illustrating an inherent risk setup interface, according to an embodiment of the present invention. The user may select various risk attributes for inherent risk. The user can also enter the weights thereof and owners for each attribute.

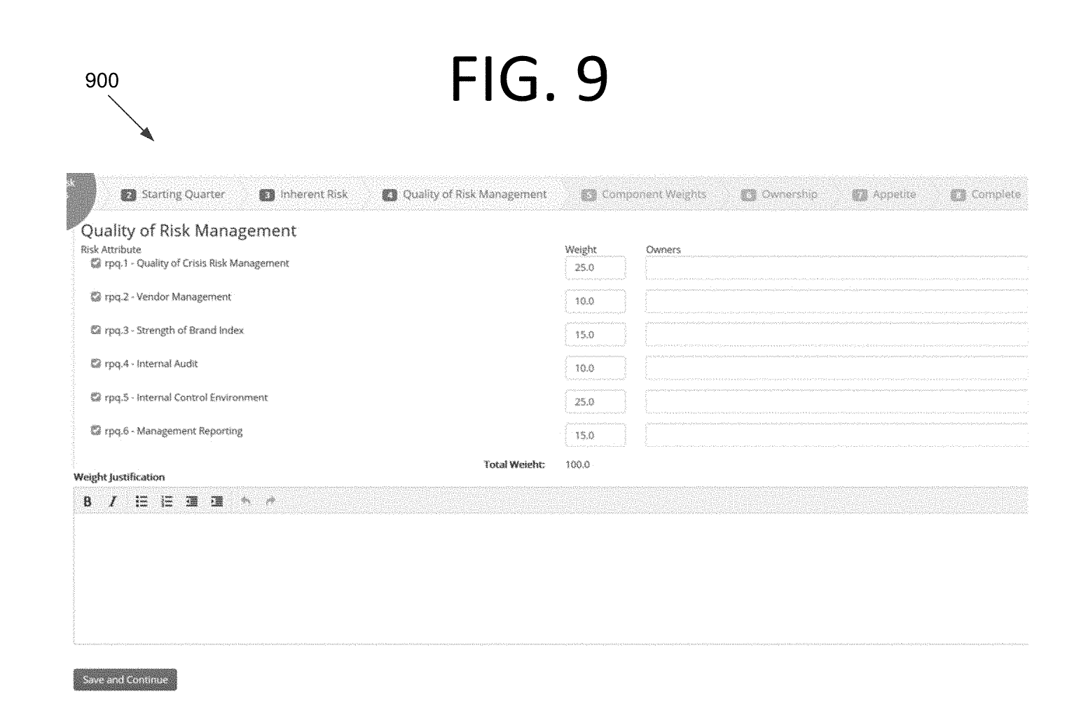

FIG. 9 is a screenshot 900 illustrating a quality of risk management setup interface, according to an embodiment of the present invention. The user may select various risk attributes, as well as assign weights and owners thereto. The user may also enter weight justifications.

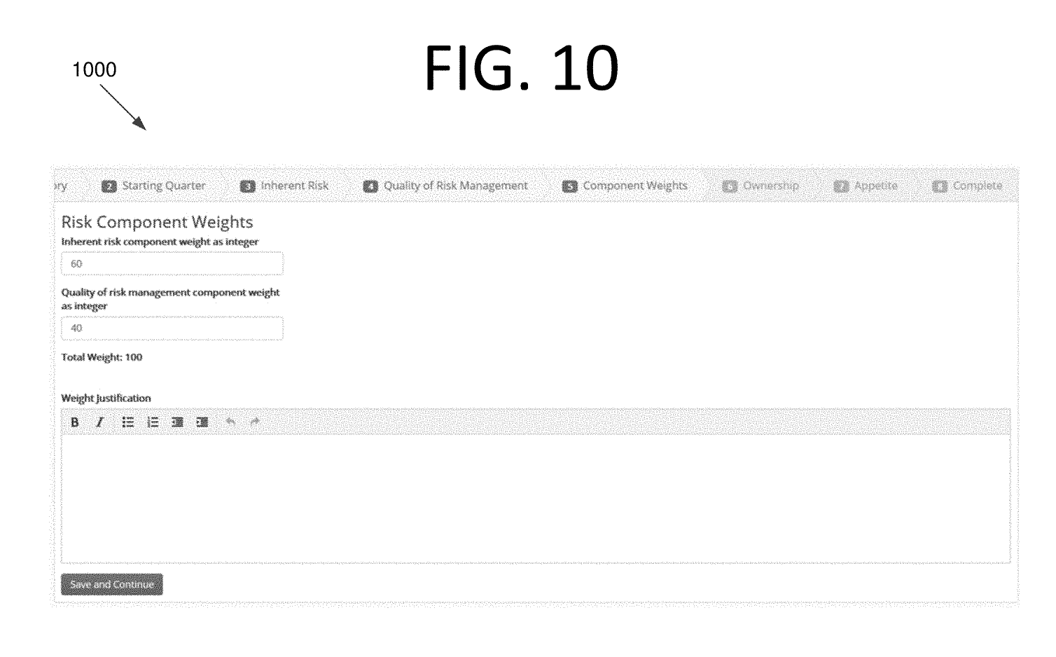

FIG. 10 is a screenshot 1000 illustrating a risk component weights setup interface, according to an embodiment of the present invention. Here, the user may designate inherent risk management weights and quality of risk management weights such that the total weight thereof adds up to 100%. For instance, in this example, the user slightly favors inherent risks over quality of risk management for this category.

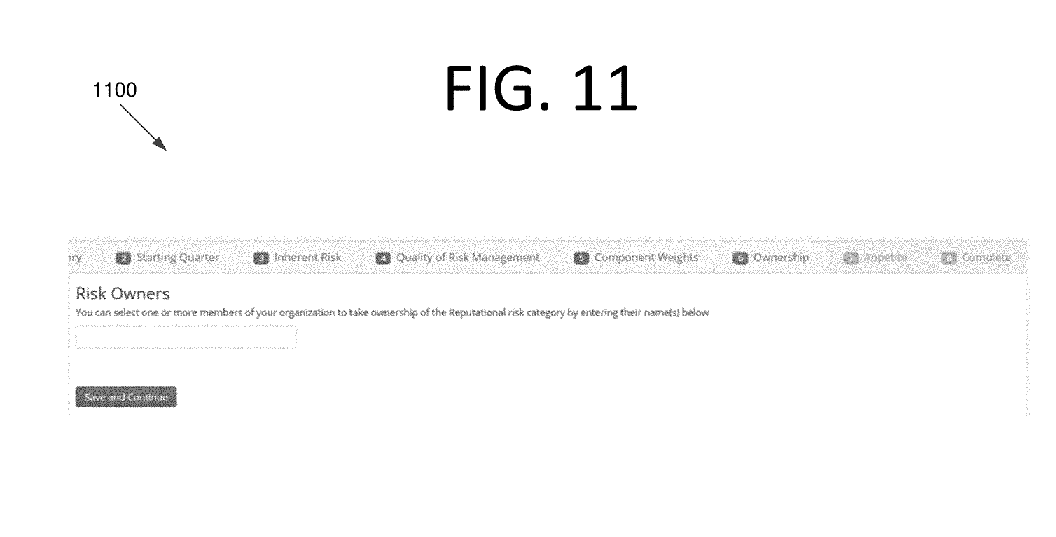

FIG. 11 is a screenshot 1100 illustrating a risk owners setup interface, according to an embodiment of the present invention. It may be desirable to select one or more risk owners for the entire category. These owners can be entered in this interface.

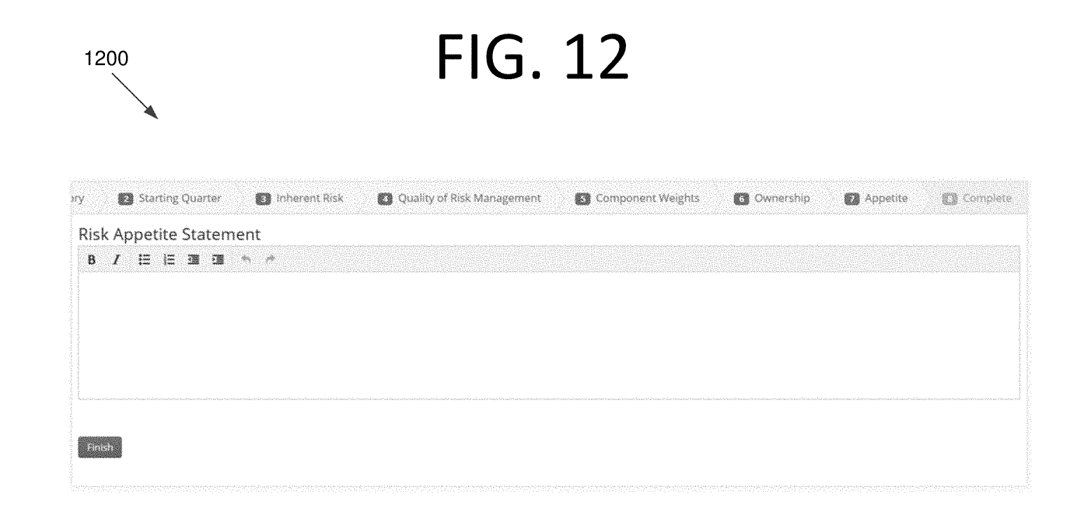

FIG. 12 is a screenshot 1200 illustrating a risk appetite statement interface, according to an embodiment of the present invention. A risk appetite statement allows the entity to know the amount and type of risk that an organization is willing to take in order to meet their strategic objectives, as approved by the board of directors. The user may enter the risk appetite statement here so that conformity with the risk appetite statement can be monitored and then finish the category risk model process.

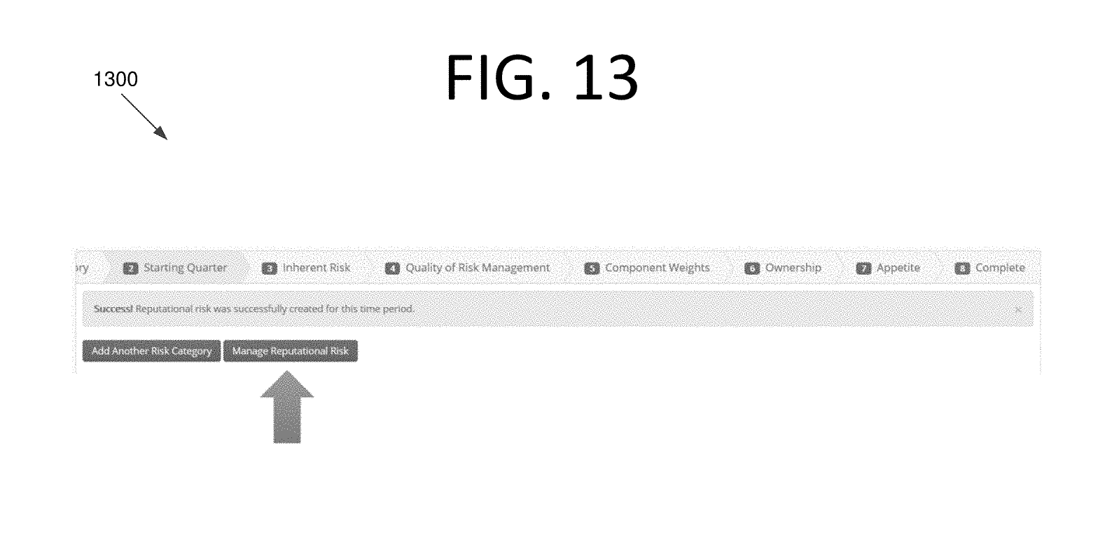

FIG. 13 is a screenshot 1300 illustrating a risk category setup completion interface, according to an embodiment of the present invention. after completing the process outlined in FIGS. 5-12, the category risk model setup is complete. The user may then add another risk category or manage the current category.

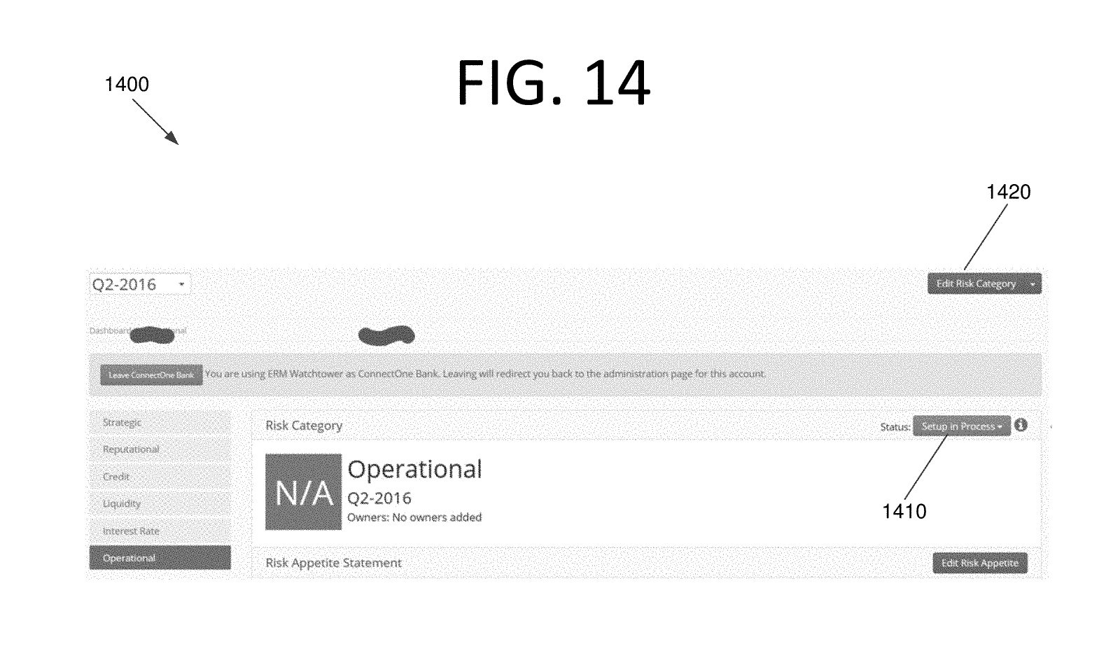

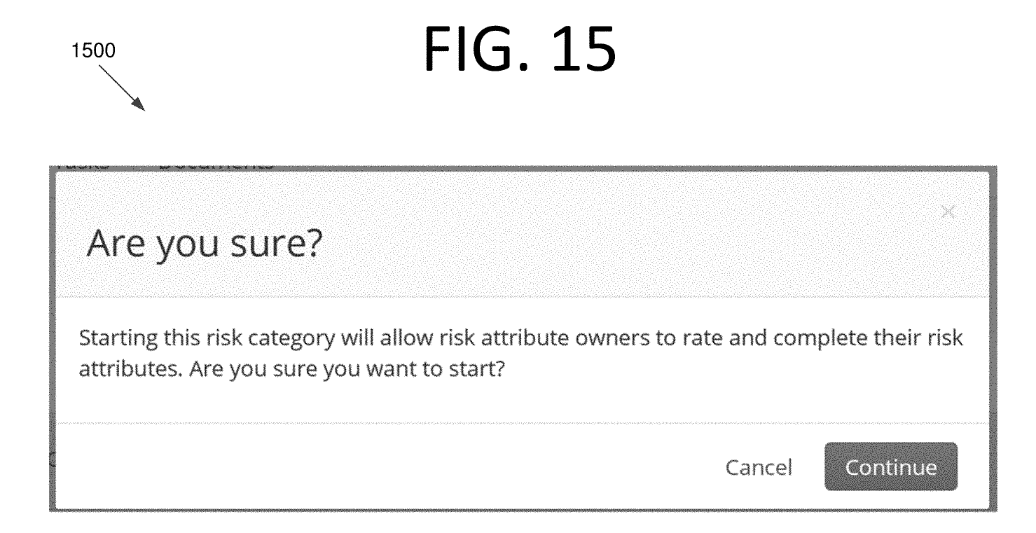

While categories are being created and setup is in process, users may be prevented from using the initial setup for assessing attributes. FIG. 14 is a screenshot 1400 illustrating an initial setup interface for assessing attributes, according to an embodiment of the present invention. As can be seen, a status tab 1410 is currently set to “Setup in Process”. The user may then set this to “Enable Data Entry” and click “Edit Risk Category” button 1420 to change weightings or attribute selections. Once this selection is made, a confirmation screen may be displayed, such as screenshot 1500 of FIG. 15. If the user clicks “Continue”, the process proceeds.

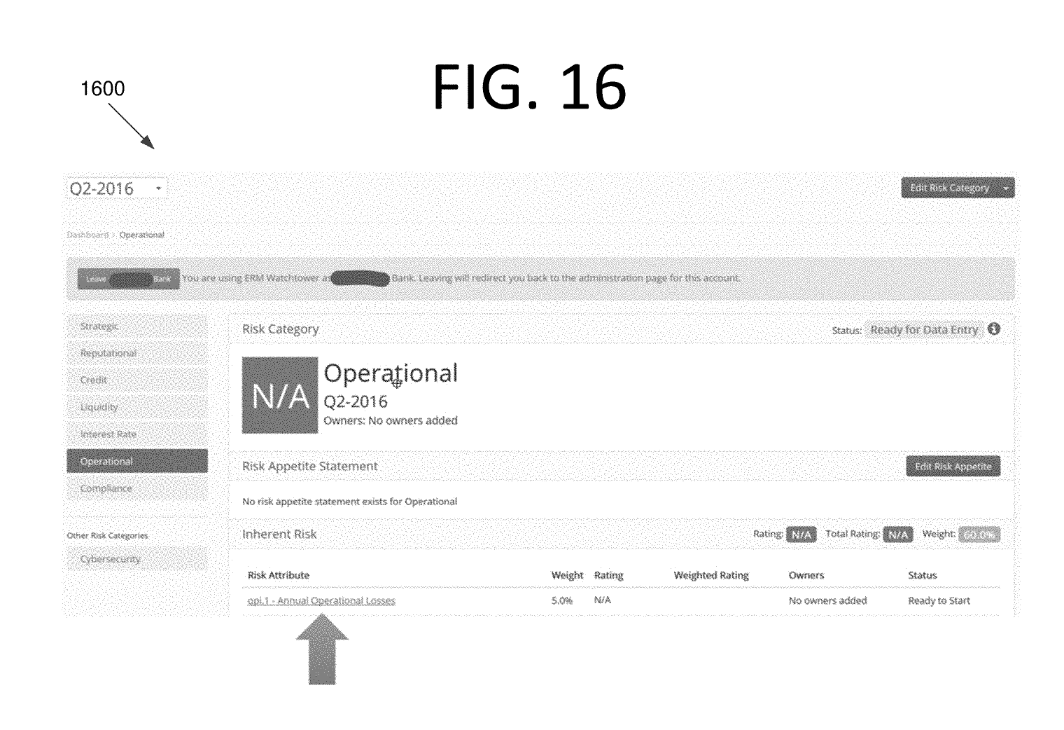

FIG. 16 is a screenshot 1600 illustrating an assess attributes interface with clickable risk attributes, according to an embodiment of the present invention. This interface shows selectable risk attributes, each of which may be accessed by clicking its text, as indicated by the arrow. In some embodiments, attributes for quality of risk may also be shown.

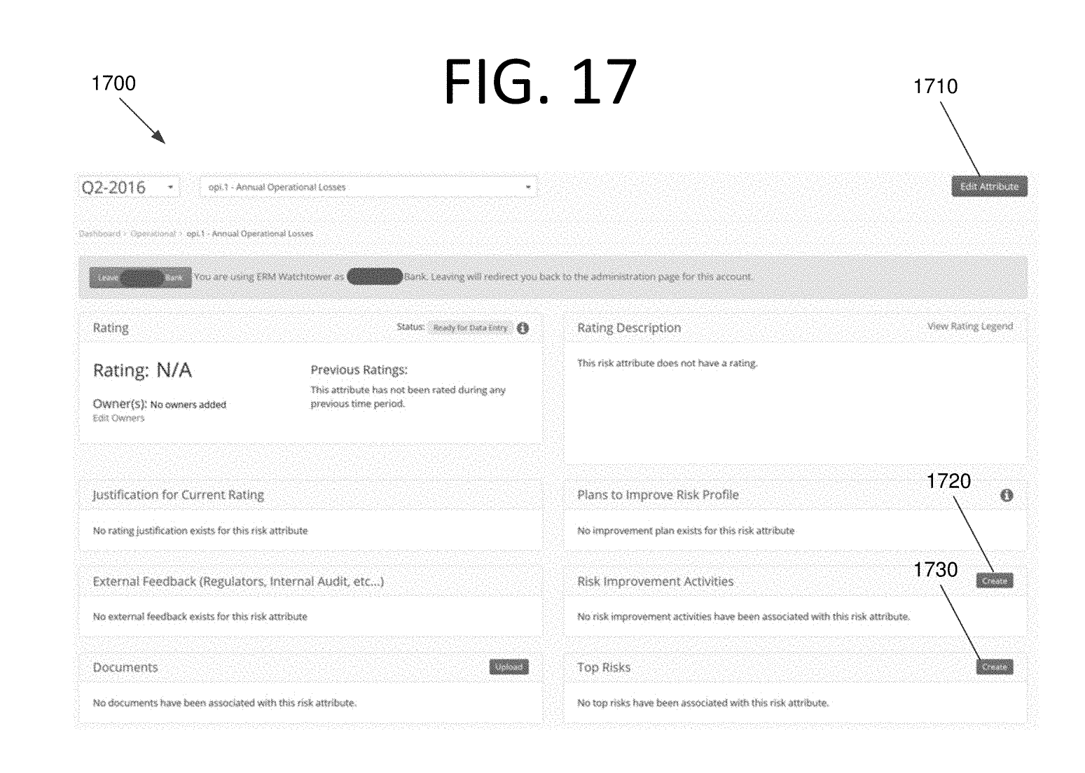

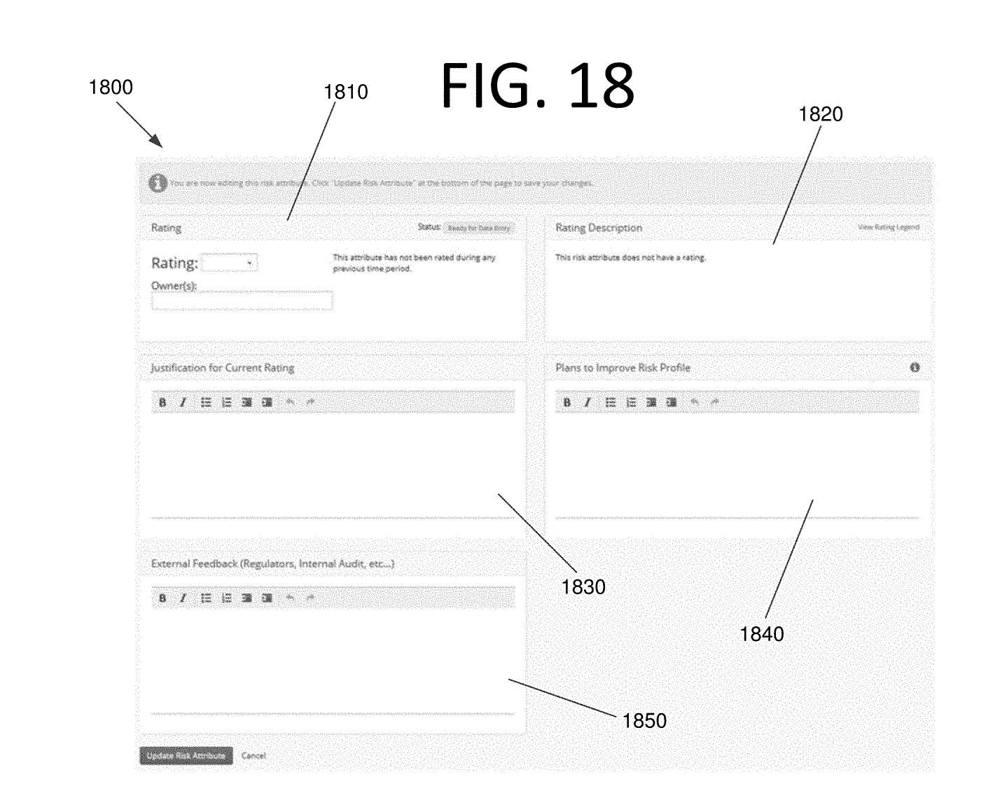

After clicking an attribute an attribute view interface is shown, such as that in screenshot 1700 of FIG. 17. Here the user can view the various characteristics of the attribute. If the user clicks “Edit Attribute” button 1710, the user is taken to an edit attribute interface, such as that shown in screenshot 1800 of FIG. 18. Here, the user may modify ratings 1810, edit the rating description 1820, provide a justification for the current rating 1830, include plans to improve the risk profile 1840, and/or provide external feedback 1850. When the user clicks the “Update Risk Attribute” button, the attribute will be updated with the new information.

Quality justifications should be provided for attribute ratings. For instance, a user may include the justification for an increased rating of that a bank having not borne losses for several years and having above average earnings as a justification for a rating increase. For a decrease, for example, the user may justify this by stating that the regulatory burden for an institution of a certain size drives it into the bottom quartile. Also by way of example, plans to improve the risk profile may include that efficiency has been a focus of management with significant progress each quarter for the past five quarters, and more improvement expected in the future. The justifications should be consistent with what would justify such a rating to a banking professional in some embodiments.

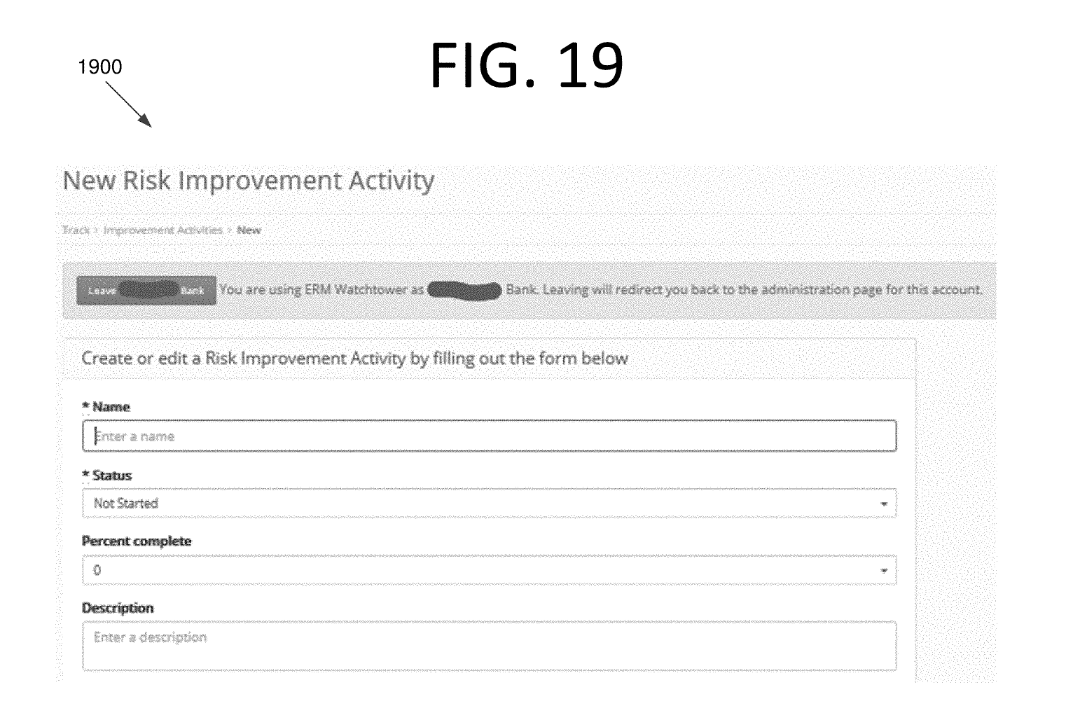

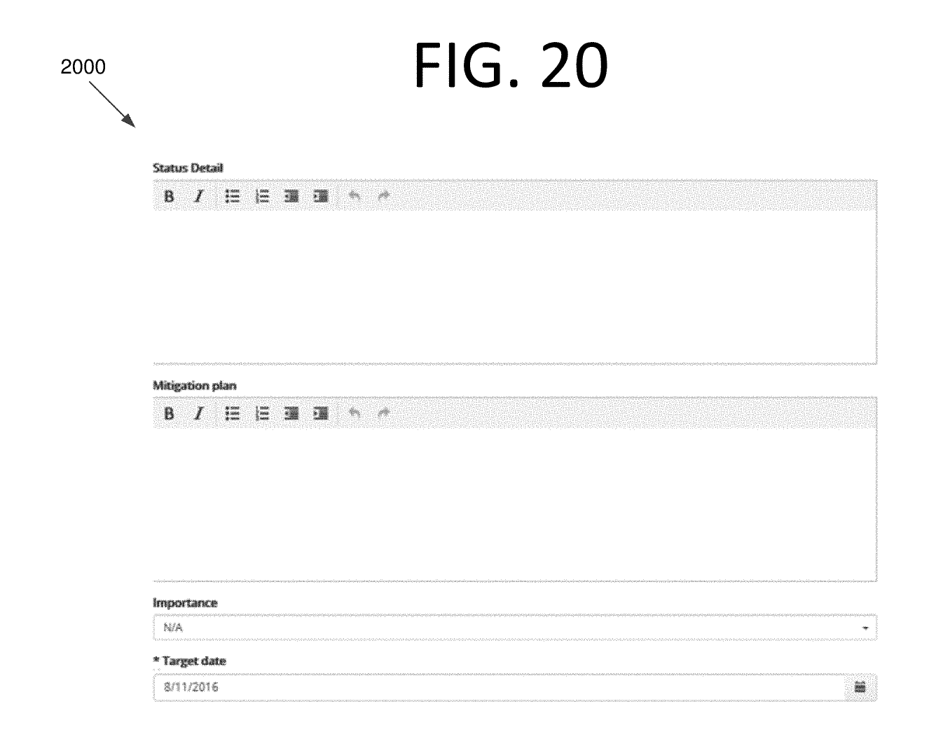

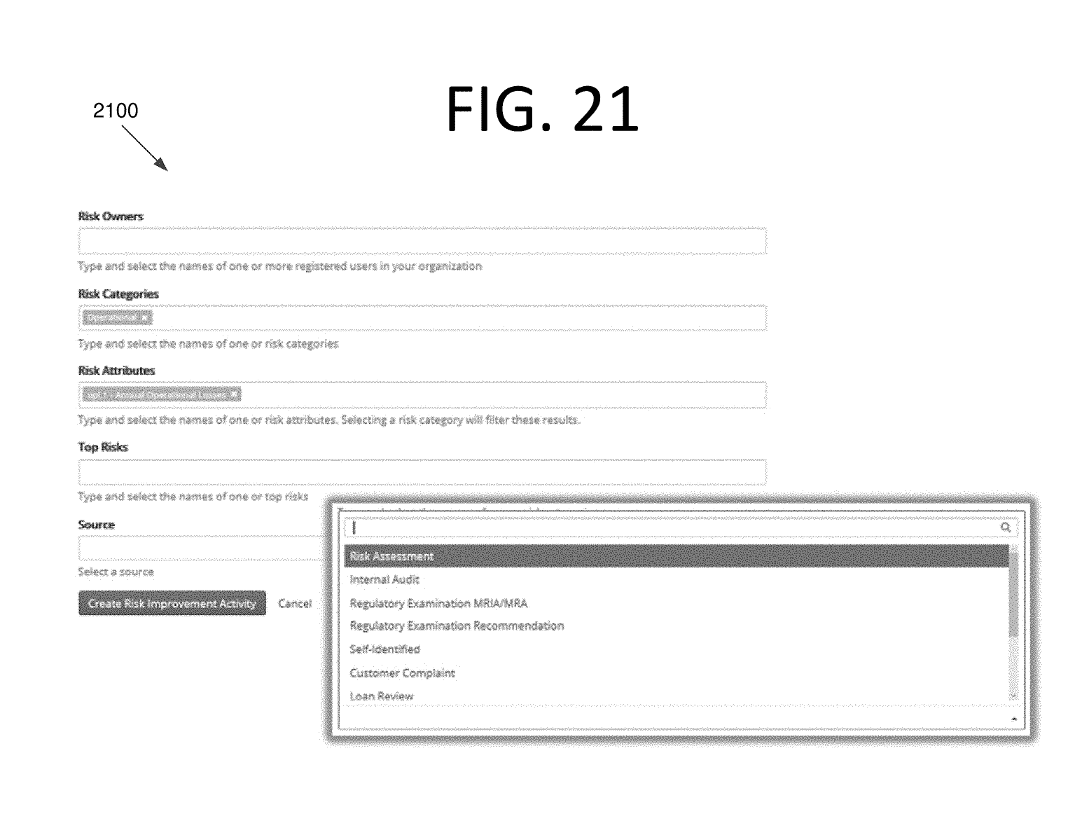

Returning to FIG. 17, if the user clicks “Create” button 1720 under risk improvement activities, a risk improvement activity interface is shown, such as that shown in screenshots 1900, 2000, 2100 of FIGS. 19-21, respectively. Here, the user can give the risk improvement activity a name, a status, a percent complete, and a description. See FIG. 19. The user can also include status detail, a mitigation plan, an importance, and a target date. See FIG. 20. The user can further add risk owners, risk categories, top risks (such as those shown in the popup of FIG. 21), and a source. The user can then click the “Create Risk Improvement Activity” button to create it.

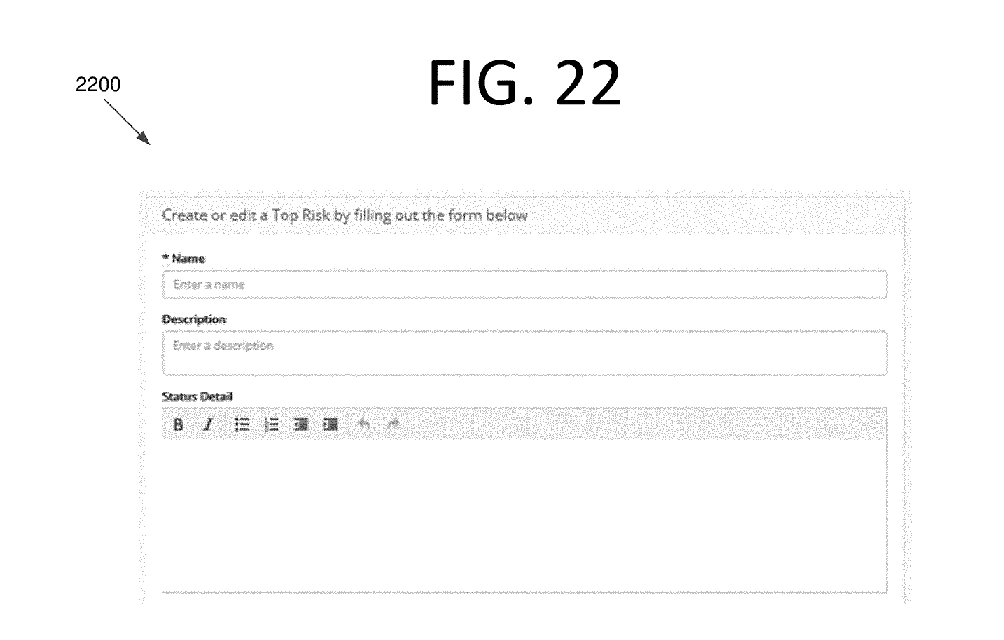

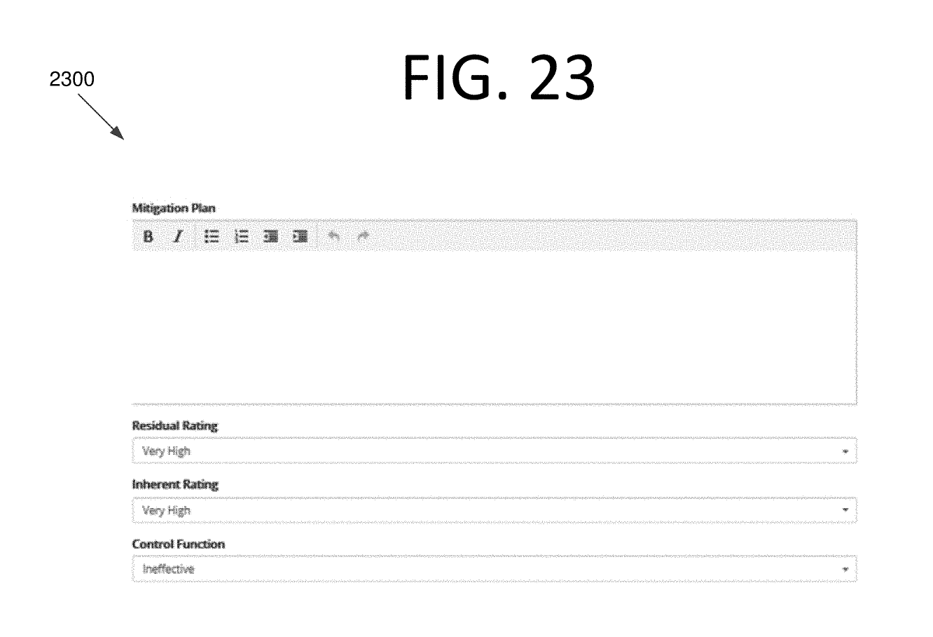

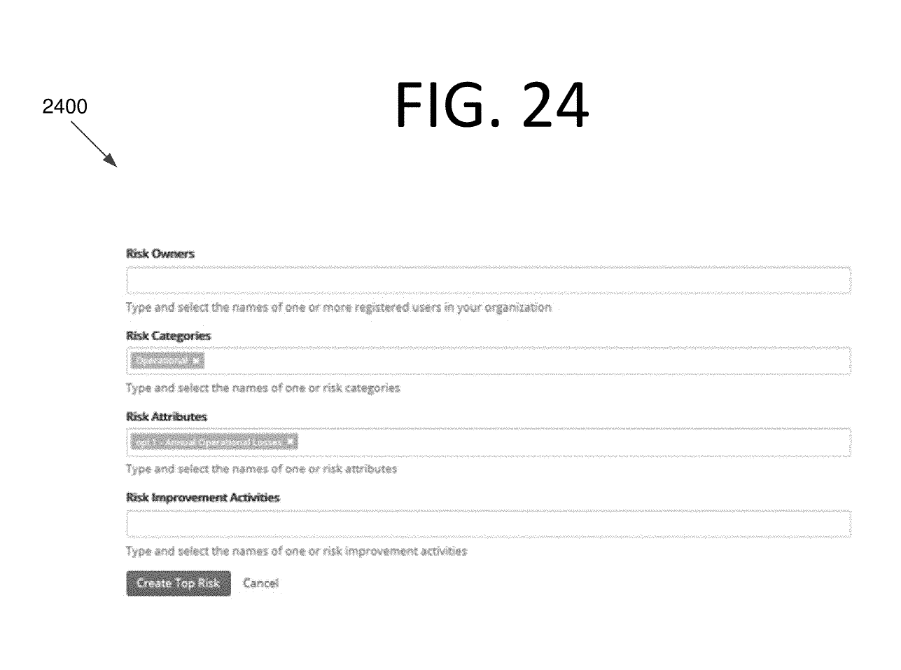

Again returning to FIG. 17, if the user clicks “Create” button 1730 under top risks, a top risk creation interface is shown, such as that shown in screenshots 2200, 2300, 2400 of FIGS. 22-24, respectively. Here, the user can enter a top risk name, description, and status detail. See FIG. 22. The user can also add a mitigation plan, residual rating, inherent rating, and control function. See FIG. 23. Furthermore, the user can select risk owners, risk categories, and risk attributes, and the user can enter risk improvement activities. See FIG. 24. The user can then click the “Create Top Risk” button to create it.

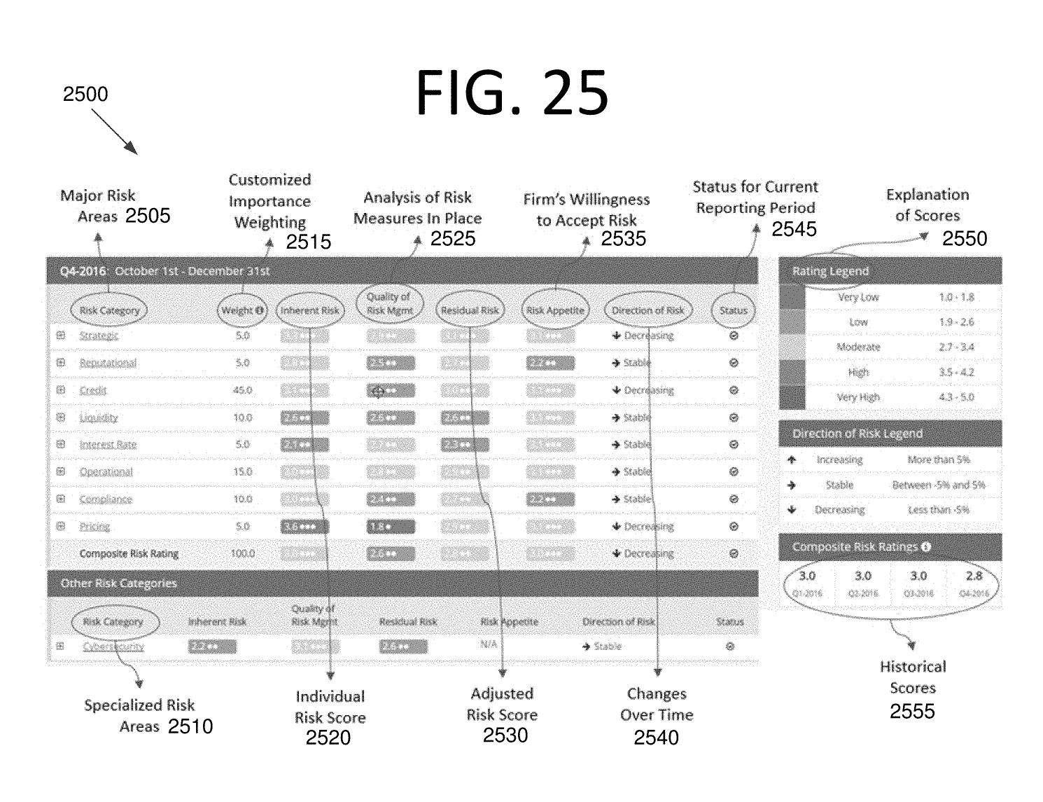

FIG. 25 is a screenshot 2500 illustrating a, ERM watchtower enterprise-wide risk aggregation dashboard, according to an embodiment of the present invention. Risk categories and other information are shown for both major risk areas 2505 and specialized risk areas 2510 (e.g., cybersecurity). A customized importance weighting 2515 indicates a percentage designated to that risk category. Inherent risk scores 2520, scores for analysis of risk measures in place 2525, and adjusted residual risk scores 2530 based on the importance percentages assigned to inherent risk scores 2520 and risk measures 2530 are also shown.

A risk appetite score 2535 indicates a firm's willingness to accept risk. A direction of risk 2540 indicates the direction of risk over time, and status 2545 indicates the status for the current reporting period, when clicked. A rating legend 2550 explains scores by color-coding them based in their numerical value from 1 to 5, with 1 being the lowest risk in this embodiment. Historical scores 2555 show composite risk ratings over past and current quarters.

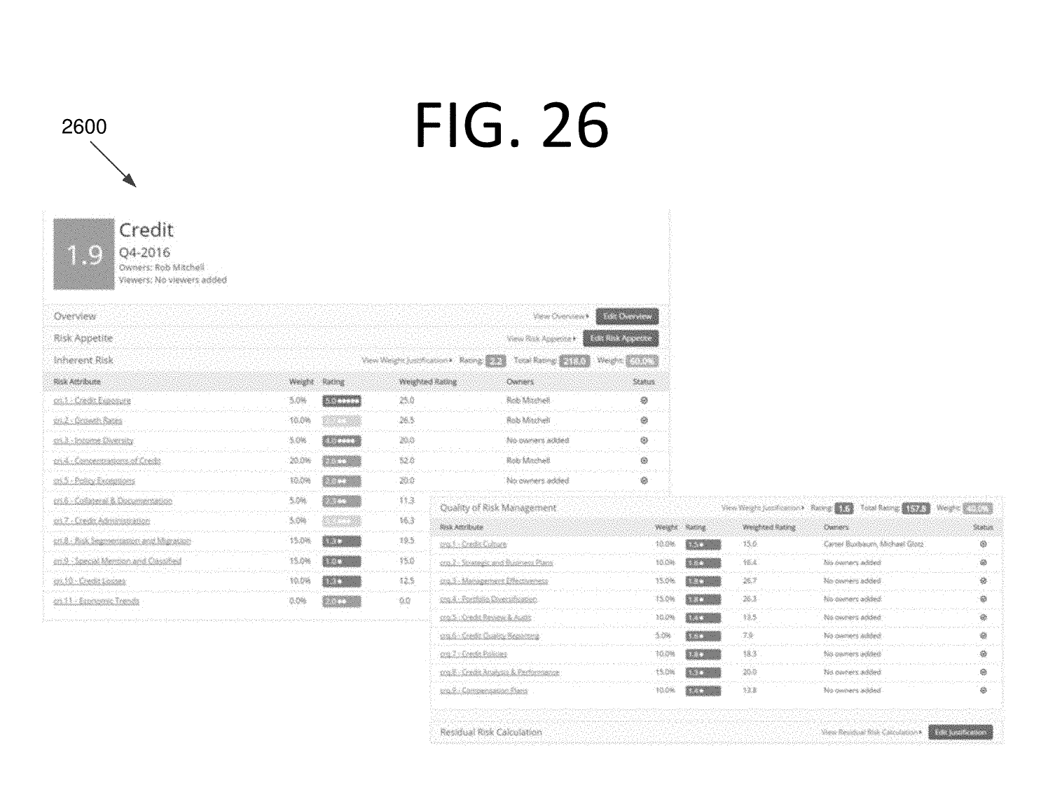

If the user clicks a given category, such as credit, a detailed breakdown for risk levels for each attribute is shown. See screenshot 2600 of FIG. 26. For instance, details for all inherent risk attributes and quality of risk management attributes are shown. The user may also click each attribute to drill down further and view its details.

Aggregation Methodology

In some embodiments, there may be various risk attribute types with different calculations. For instance, in some embodiments, the calculation types may be manual, risk attribute indicator, and self-assessment consideration. Ratings for risk attribute indicators may be derived from associated data inputs. In the context of the subject application, the term “risk object” refers to a risk attribute, a risk component, a risk category, or a time period. In certain embodiments, risk object calculations only occur in certain status states including, but not limited to, not started (rating cannot be assigned as the object is still in setup), initialized (rating cannot be assigned since the administrator needs to mark the object as ready to start), ready to start (rating can be assigned), in process (rating can change), completed (rating cannot change unless put back to “in process”), etc.

Manual Risk Attributes

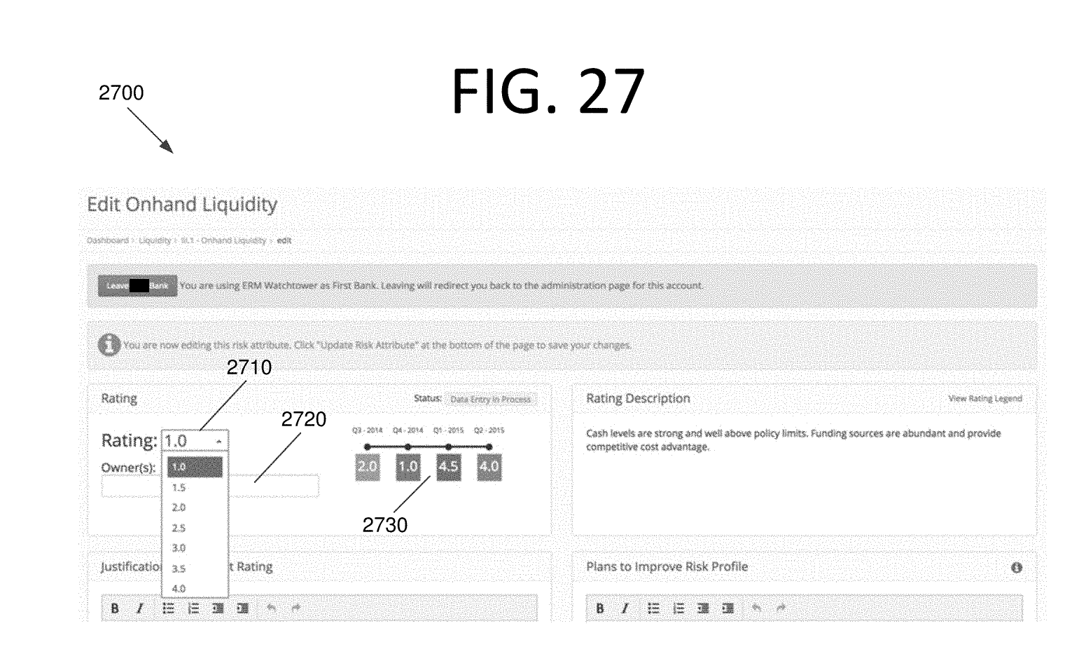

Manual risk attributes are entered by a user. This may be especially applicable for certain risk types that are not easily assessed computationally. Such a manual rating input interface 2700 is shown in FIG. 27. Here, the user has chosen to manually edit the “onhand liquidity” attribute. In this embodiment, the user can choose a rating from 1 to 5 on a rating dropdown 2710 and can add owners in input 2720. The user can also view a history 2730 of previous ratings in past quarters.

Risk Attribute Indicators

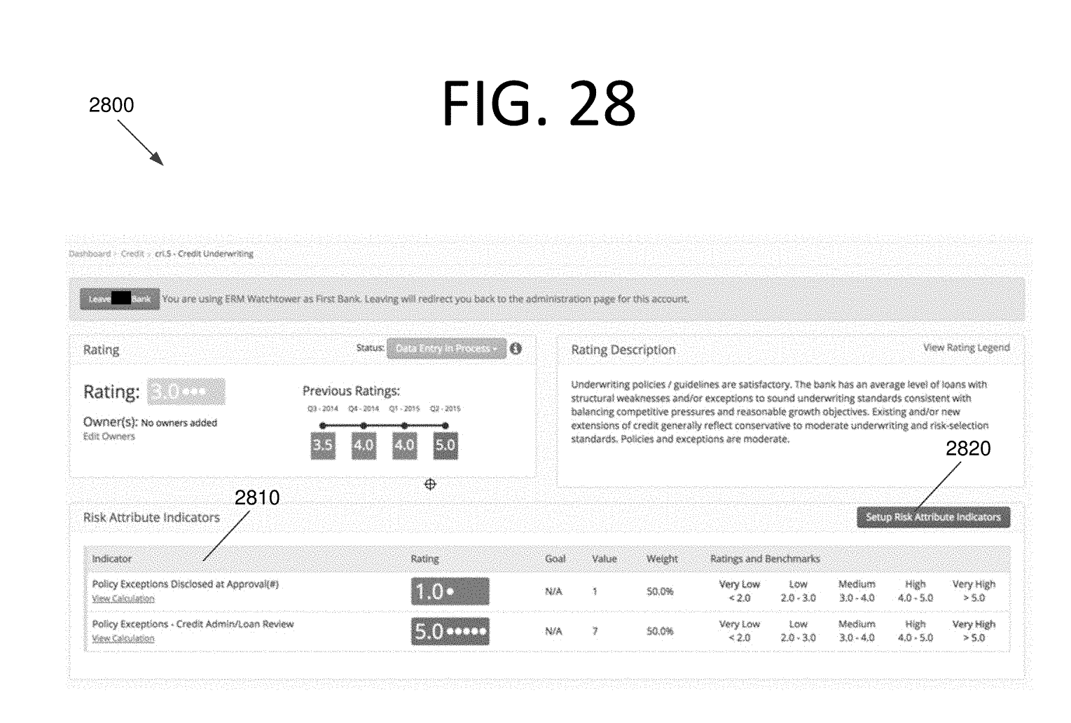

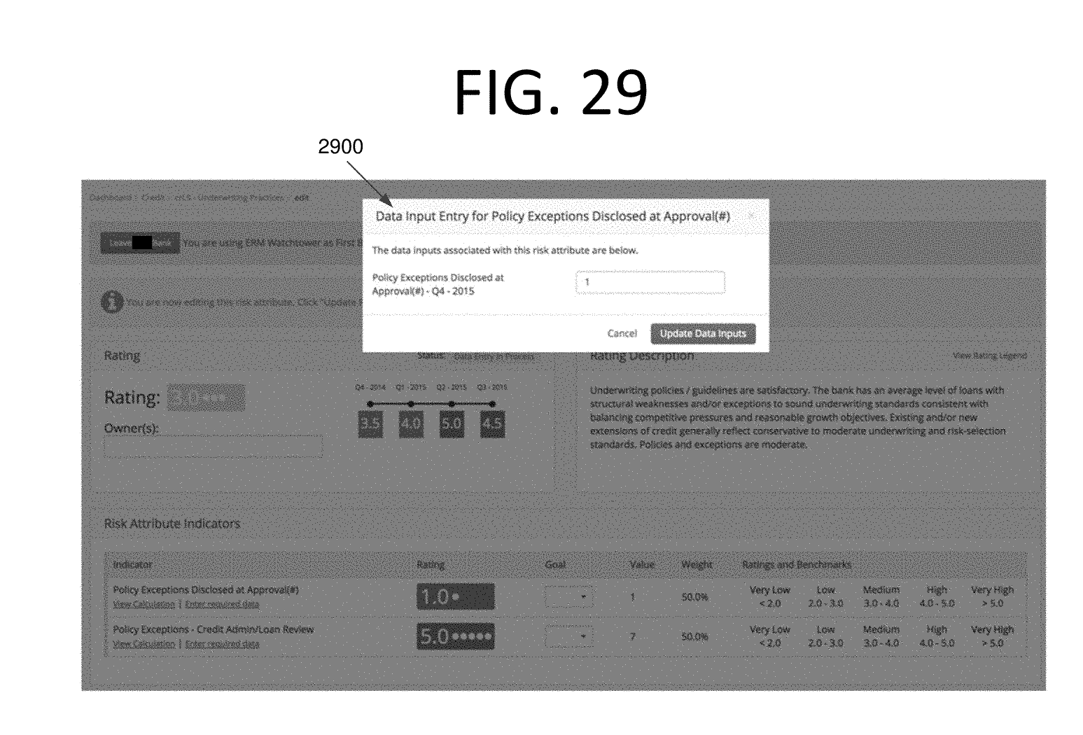

Each risk attribute may have various risk attribute indicators, such as indicators 2810 in screenshot 2800 of FIG. 28. Each risk attribute indicator has a Ratings and Benchmark section that translates its associated data input value to a rating from 1 to 5 in this embodiment. For instance, to set the rating for Policy Exceptions Disclosed at Approval, one may click “Setup Risk Attribute Indicators” button 2820 and select this indicator. This causes an appropriate interface for the indicator to appear. See screenshot 2900 of FIG. 29. In this case, the attribute is set to 1.

As is also shown in FIG. 28, the Policy Exceptions—Credit Admin/Loan Review attribute has a value of 5. In order to determine the rating of the given risk attribute, various calculation s may be performed. For instance, assume that each of the risk attribute indicators shown in FIG. 28 is given a weight of 50%. To determine the overall rating of the risk attribute, each risk attribute indicator would be multiplied by 0.5. Thus:
Policy Exceptions Disclosed at Approval(#): 1*50%=0.5
Policy Exceptions—Credit Admin/Loan Review: 5*50%=2.5
Risk Attribute Rating=0.5+2.5=3.0

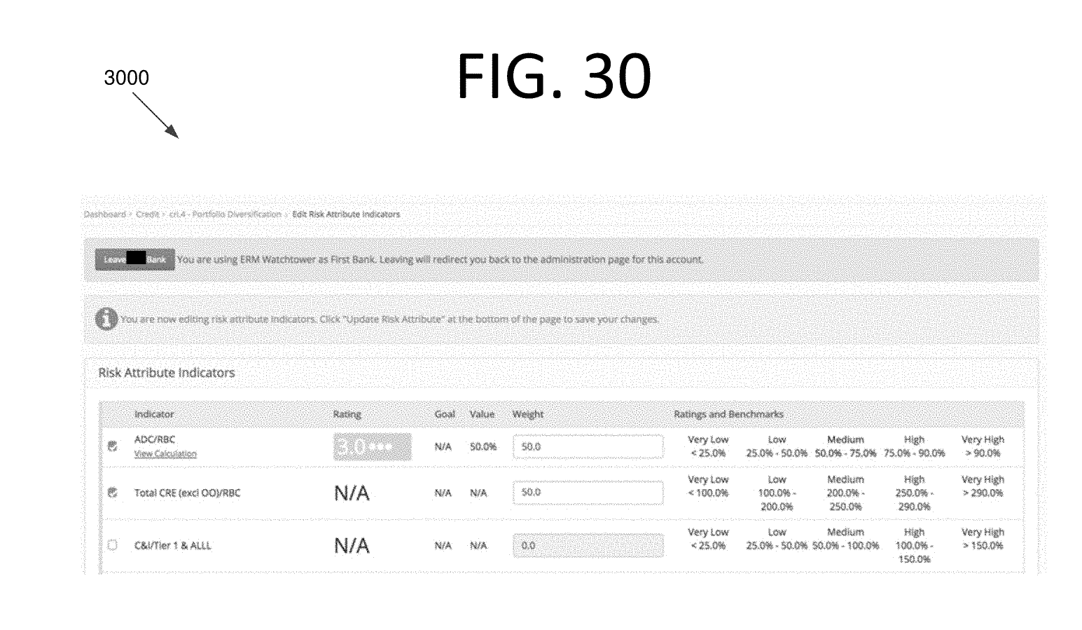

In some embodiments, risk attribute indicators may be selected to be included in the rating computation and deselected to be removed therefrom. See screenshot 3000 of FIG. 30. An attribute rating of “N/A” may indicate that the attribute has not been setup yet, or has no effect. In some embodiments, risk attribute ratings may be recalculated when risk attribute indicator weight(s) change, a risk attribute indicator is deselected, a risk attribute indicator with a rating is selected, etc.

Self-Assessment Consideration

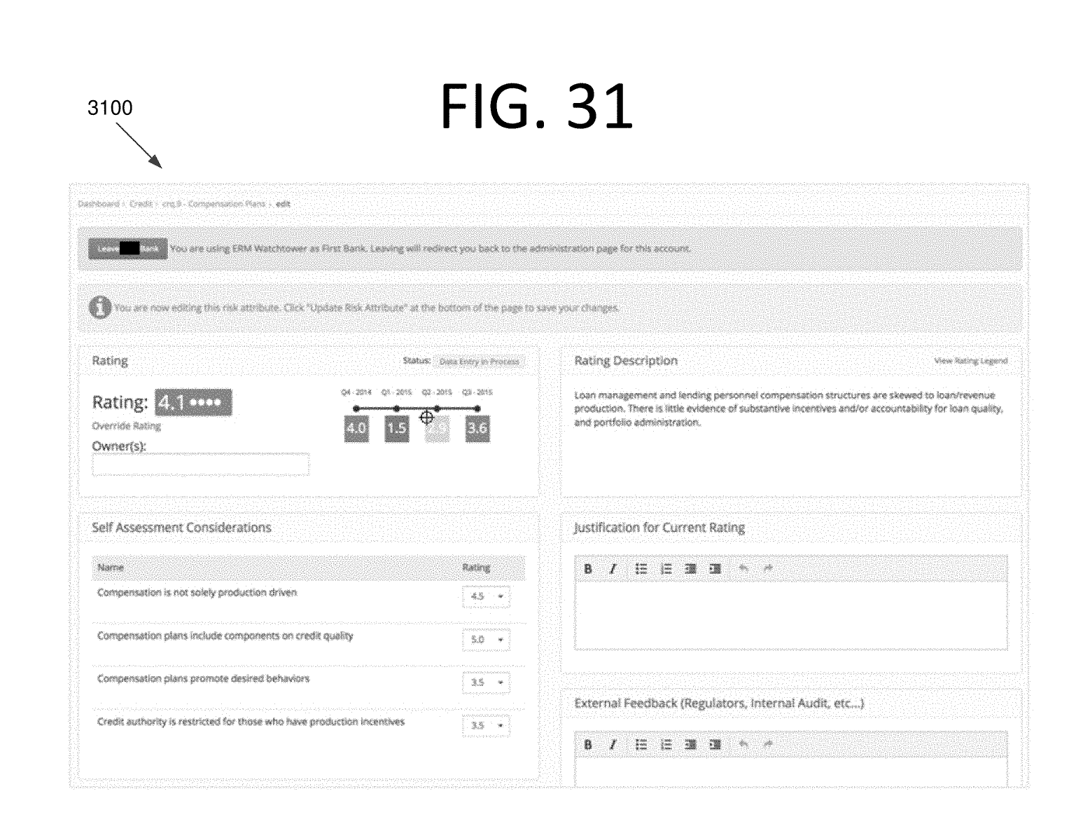

Ratings may also be derived from an average self-assessment consideration ratings. For instance, in screenshot 3100 of FIG. 31, the user has set four different ratings:

| | |
|---|---|
| Compensation is not solely production driven | 4.5 |
| Compensation plans include components on credit quality | 5.0 |
| Compensation plans promote desired behaviors | 3.5 |
| Credit authority is restricted for those who have production | 3.5 |
| incentives | |
| Risk Attribute Rating | 4.1 |

This rating may be overridden with a manual rating in some embodiments. See, for example, FIG. 27.

Weighted Ratings Calculations

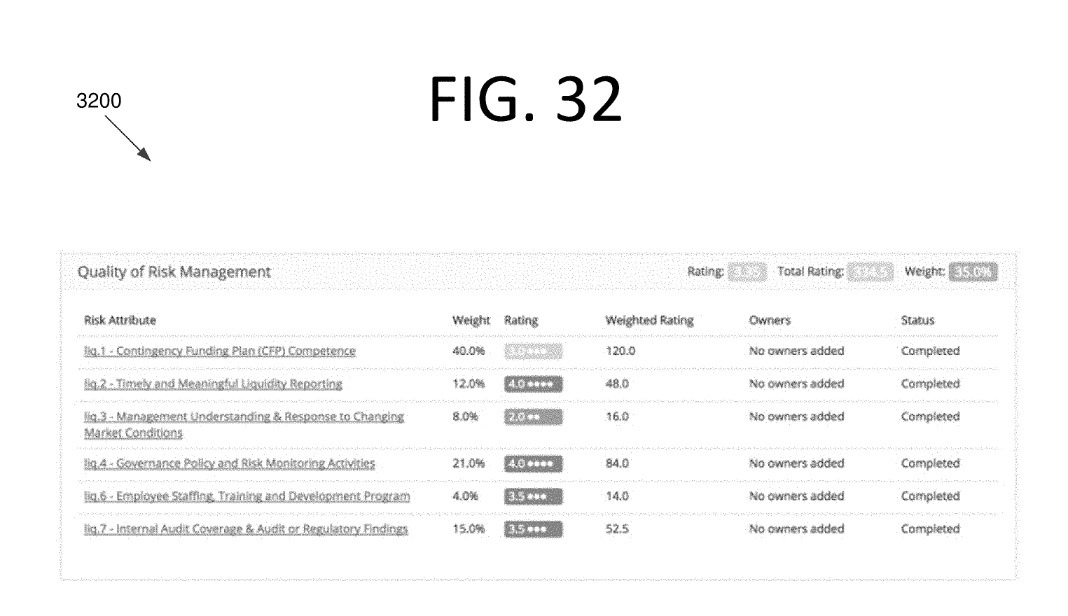

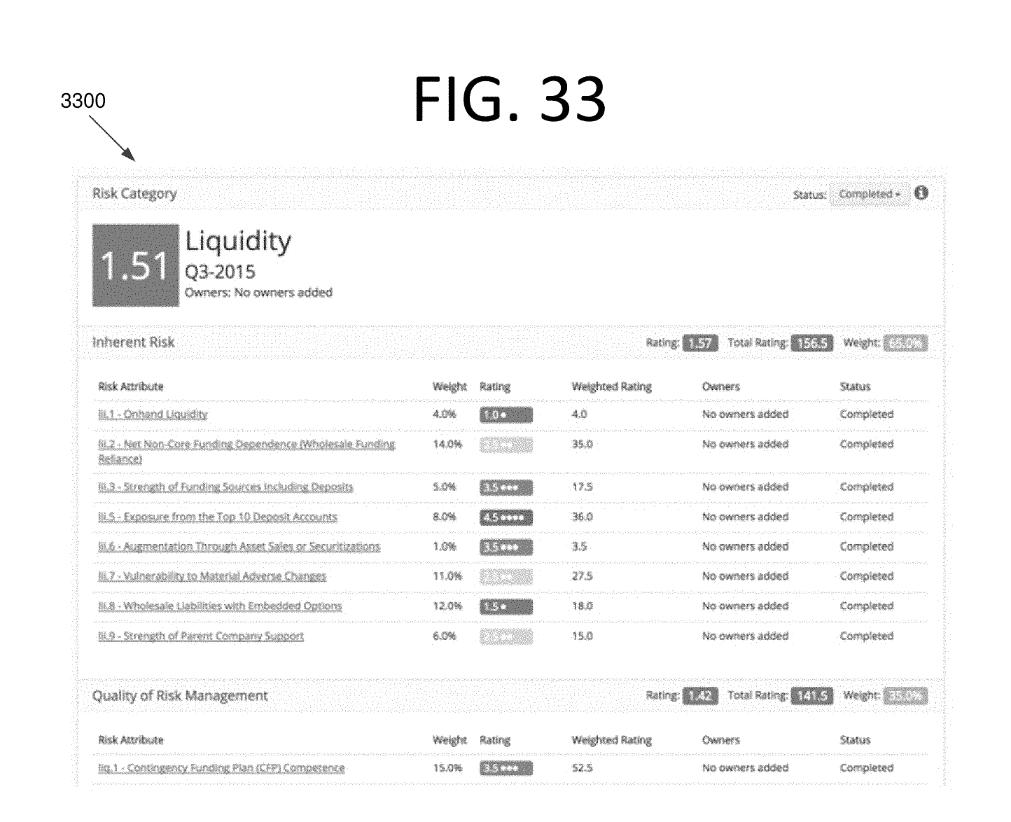

As discussed above, inherent risk ratings and quality of risk management ratings each add up to 100% individually, and are then multiplied by an individual weight that collectively adds up to 100%. For example, as shown in screenshots 3200 and 3300 of FIGS. 32 and 33, respectively, the various risk attributes for inherent risk and quality of risk management each add up to 100%. However, quality of risk management has a weight of 35% and inherent risk has a weight of 65%. Thus, although the risk component rating of quality of risk management is 334.5/100=3.35, because it has a weight of only 35%, its contribution to the aggregate risk score is only 3.35*0.35=1.1725. Thus, combined with the inherent risk component of (156.5/100)*0.65=1.01725, the total risk score for liquidity is 1.1725+1.01725=2.18975, or ˜2.19.

Thus, the weighted component rating R for inherent risk or quality of risk management is given by:

$$R = ( {\sum }_{1}^{n} {r}_{n} {w}_{n} ) W \qquad ( 1 )$$

where n is the number of risk attributes, rₙ is the rating of the n^{th} attribute, wₙ is the weight of the n^{th} attribute, and W is the weight of the component (i.e., inherent risk or quality of risk management). The category rating, or composite risk, C, is thus given by:

C=Rᵢ+R_{q} (2)

where Rᵢ is the weighted component rating for inherent risk and R_{q} is the weighted component rating for the quality of risk management.

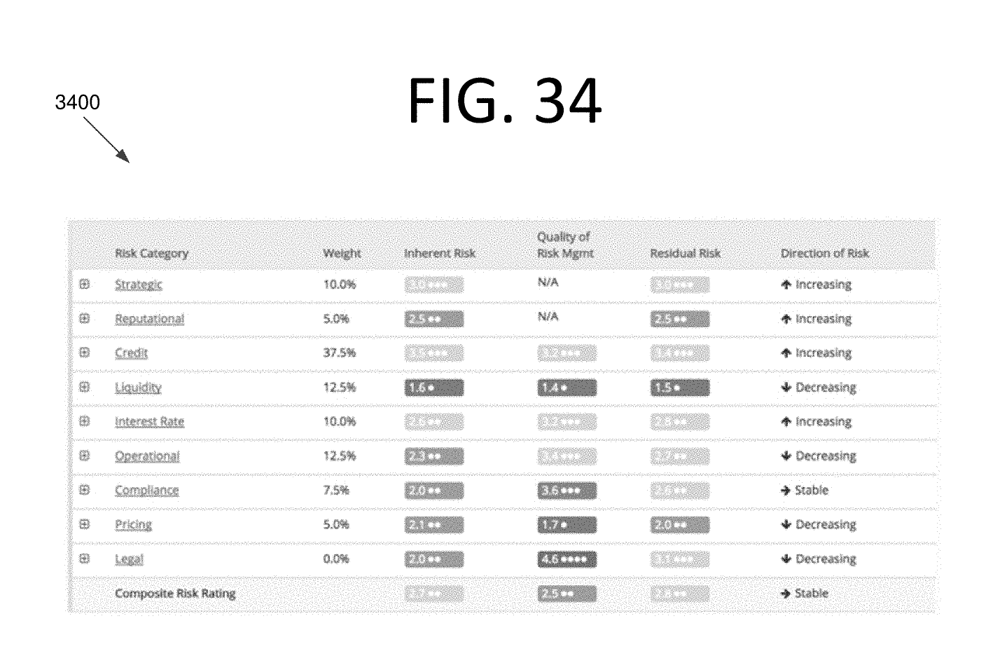

Once category weights are determined, composite rating scores across all categories can also be determined. For instance, consider screenshot 3400 of FIG. 34. In order to determine the composite risk ratings, ρ, for each of inherent risk, quality of risk management, and residual risk, the following equation may be used:

$$ρ = ( {\sum }_{1}^{i} {C}_{i} {W}_{i} ) / 100 \qquad ( 3 )$$

where i is the number of categories, Cᵢ is the rating of the i^{th} category, and Wᵢ is the weight of the i^{th} category. Combining the ratings and weights of the categories yields a composite inherent risk rating of 2.7, a composite quality of risk management rating of 2.5, and a composite residual risk rating of 2.8.

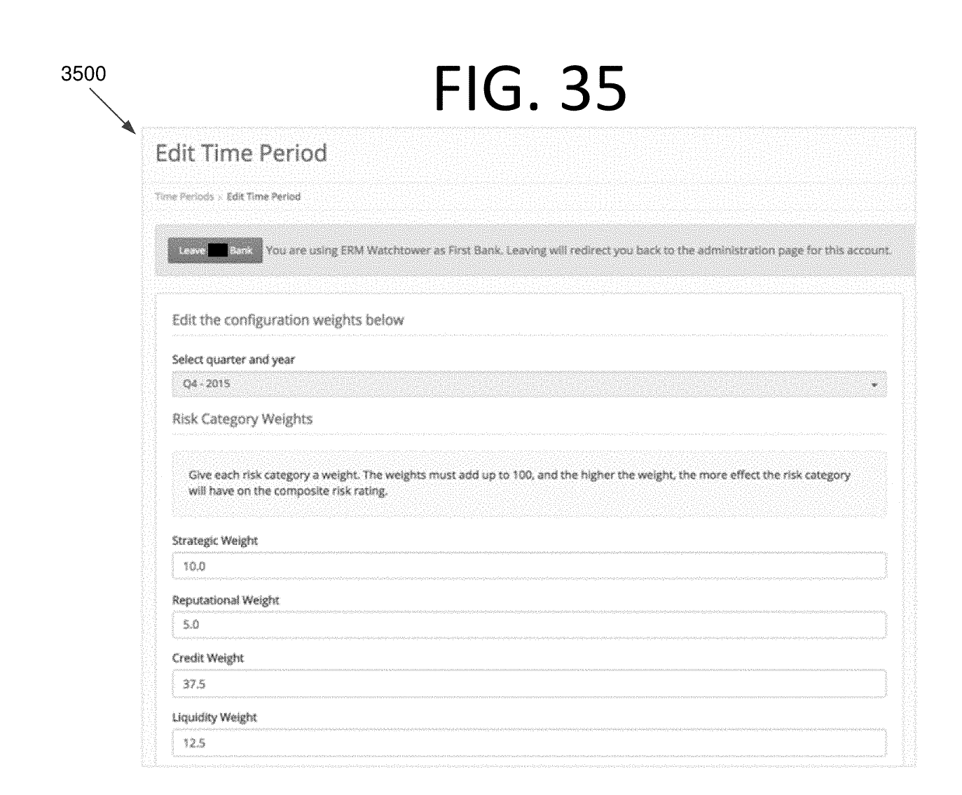

Risk category weights may also be modified by quarter in some embodiments. For instance, in screenshot 3500 of FIG. 35, the user is able to select a desired time period, such as the fourth quarter of 2015. The user can then reassign weights for the risk category such that they are modified, but still add up to 100%. For instance, in this example, and for this quarter, the strategic weight is set to 10.0%, the reputational weight is set to 5.0%, the credit weight is set to 37.5%, and the liquidity weight is set to 12.5%.

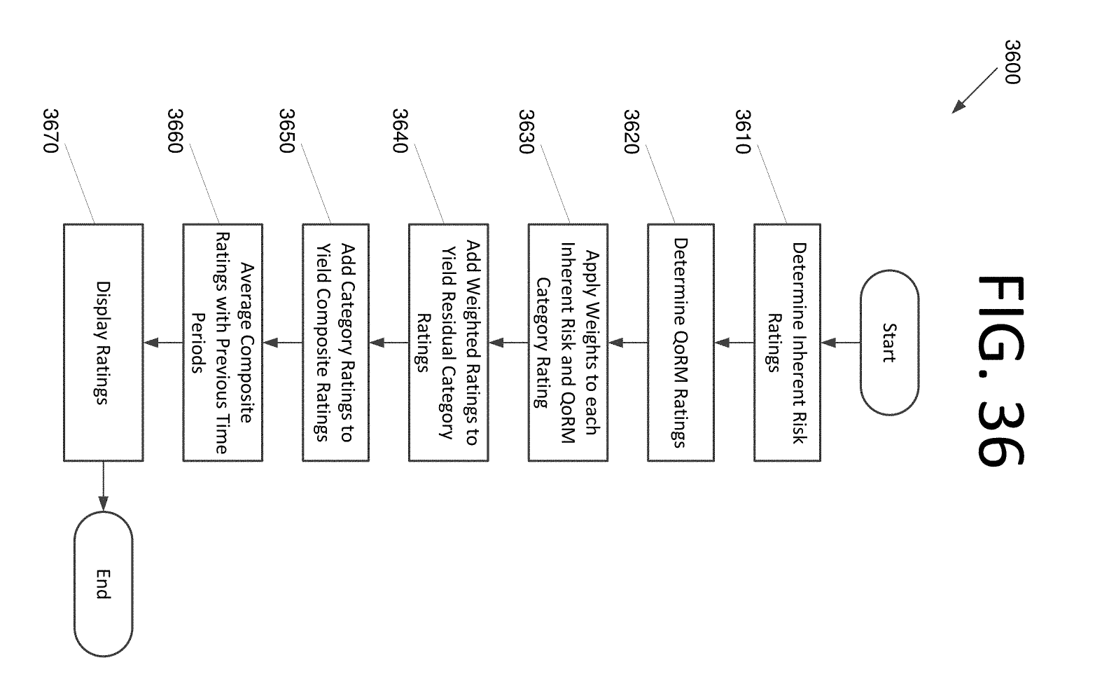

FIG. 36 is a flowchart 3600 illustrating a process for calculating enterprise-wide risk, according to an embodiment of the present invention. The process begins with determining inherent risk ratings at 3610 and determining quality of risk management (QoRM) ratings at 3620 for a plurality of risk categories for a current time period. Next, weights are applied to each inherent risk category rating and each quality of risk management category rating at 3630.

The weighted inherent risk category ratings are added at 3640 to yield a composite inherent risk rating for the current time period. The weighted quality of risk management category ratings are then added at 3650 to yield a composite quality of risk management rating for the current time period. The composite inherent risk rating and the composite quality of risk management rating for the current time period are averaged with composite inherent risk ratings and composite quality of risk management ratings from a plurality of previous time periods, respectively, at 3660 to yield an averaged inherent risk rating and an averaged composite quality of risk management rating. The averaged inherent risk rating and an averaged composite quality of risk management rating are then displayed on a display device at 3670.

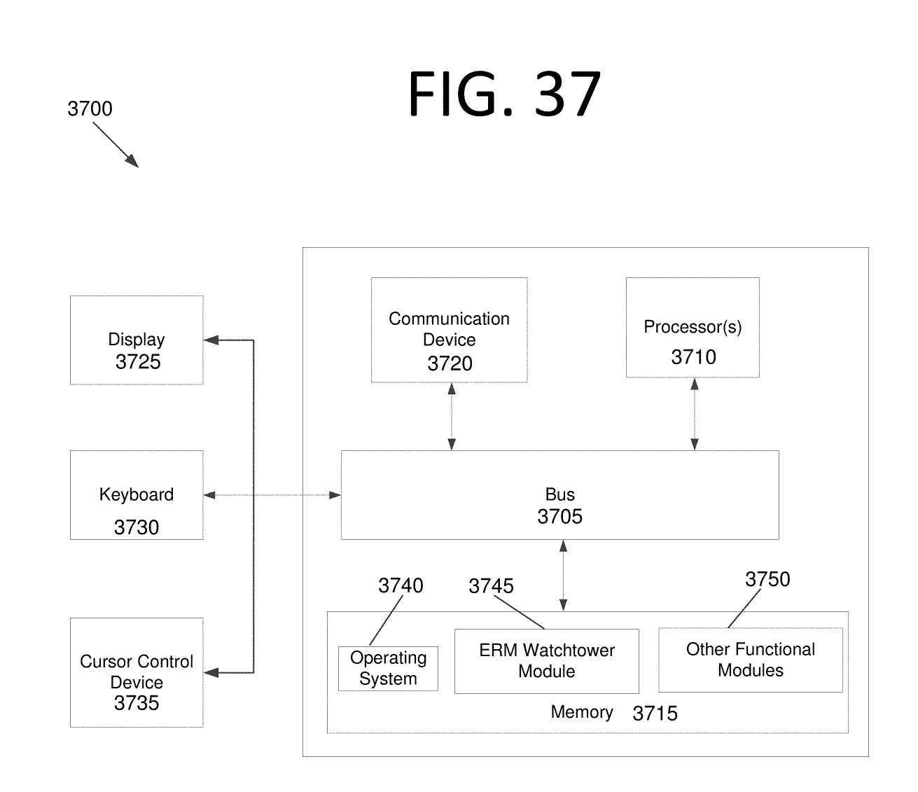

FIG. 37 is a block diagram of a computing system 3700 configured to implement an ERM watchtower application, according to an embodiment of the present invention. Computing system 3700 includes a bus 3705 or other communication mechanism for communicating information, and processor(s) 3710 coupled to bus 3705 for processing information. Processor(s) 3710 may be any type of general or specific purpose processor, including a central processing unit (CPU) or application specific integrated circuit (ASIC). Processor(s) 3710 may also have multiple processing cores, and at least some of the cores may be configured to perform specific functions. Computing system 3700 further includes a memory 3715 for storing information and instructions to be executed by processor(s) 3710. Memory 3715 can be comprised of any combination of random access memory (RAM), read only memory (ROM), flash memory, cache, static storage such as a magnetic or optical disk, or any other types of non-transitory computer-readable media or combinations thereof. Additionally, computing system 3700 includes a communication device 3720, such as a transceiver and antenna, to wirelessly provide access to a communications network.

Non-transitory computer-readable media may be any available media that can be accessed by processor(s) 3710 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor(s) 3710 are further coupled via bus 3705 to a display 3725, such as a Liquid Crystal Display (LCD), for displaying information to a user. A keyboard 3730 and a cursor control device 3735, such as a computer mouse, are further coupled to bus 3705 to enable a user to interface with computing system. However, in certain embodiments such as those for mobile computing implementations, a physical keyboard and mouse may not be present, and the user may interact with the device solely through display 3725 and/or a touchpad (not shown). Any type and combination of input devices may be used as a matter of design choice.

Memory 3715 stores software modules that provide functionality when executed by processor(s) 3710. The modules include an operating system 3740 for computing system 3700. The modules further include an ERM watchtower module 3745 that is configured to perform ERM watchtower functionality in accordance with the embodiments discussed herein. Computing system 3700 may include one or more additional functional modules 3750 that include additional functionality.

One skilled in the art will appreciate that a “system” could be embodied as an embedded computing system, a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIG. 36 may be performed by a computer program, encoding instructions for the nonlinear adaptive processor to perform at least the process described in FIG. 36, in accordance with embodiments of the present invention. The computer program may be embodied on a non-transitory computer-readable medium. The computer-readable medium may be, but is not limited to, a hard disk drive, a flash device, a random access memory, a tape, or any other such medium used to store data. The computer program may include encoded instructions for controlling the nonlinear adaptive processor to implement the process described in FIG. 36, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an ASIC.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer program embodied on a non-transitory computer-readable medium, the program configured to cause at least one processor to:
determine a weighted inherent risk rating for a risk category from a plurality of weighted inherent risk attribute ratings;
determine a weighted quality of risk management rating for the risk category from a plurality of weighted quality of risk management attribute ratings;
add the weighted inherent risk rating and the weighted quality of risk management rating to yield a composite risk rating for the risk category; and
display the composite risk rating for the risk category on a display device.

2. The computer program of claim 1, wherein weightings of the inherent risk and the quality of risk management add up to 100%.

3. The computer program of claim 1, wherein weightings of the plurality of inherent risk attribute ratings add up to 100%.

4. The computer program of claim 1, wherein weightings of the plurality of quality of risk management attribute ratings add up to 100%.

5. The computer program of claim 1, wherein the weighted inherent risk rating, the weighted quality of risk management rating, or both, are given by
$$R = ( {\sum }_{1}^{n} {r}_{n} {w}_{n} ) W$$
where n is a number of risk attributes, rₙ is a rating of an n^{th} attribute, wₙ is a weight of the n^{th} attribute, and W is a weight of the inherent risk or the quality of risk management.

6. The computer program of claim 1, wherein the program is further configured to cause the at least one processor to:
determine composite risk ratings for at least one other risk category;
weight the composite risk ratings for all categories;
add the composite risk ratings for all categories; and
display an enterprise risk score based on the added composite risk ratings for all categories.

7. The computer program of claim 6, wherein the enterprise risk score ρ is given by
$$ρ = ( {\sum }_{1}^{i} {C}_{i} {W}_{i} ) / 100 \qquad ( 3 )$$
where i is a number of categories, Cᵢ is a rating of an i^{th} category, and Wᵢ is a weight of the i^{th} category.

8. The computer program of claim 6, wherein the program is further configured to cause the at least one processor to:
determine average category risk ratings, an average composite risk rating, or both, over multiple time periods.

9. The computer program of claim 1, wherein the program is further configured to cause the at least one processor to reassign one or more weights for the risk category for a previous time period.

10. The computer program of claim 1, wherein the risk category comprises strategic risks, reputational risks, credit risks, liquidity risks, interest rate risks, operational risks, compliance risks, pricing risks, legal risks, or cybersecurity risks.

11. A computer-implemented method, comprising:
determining, by a computing system, inherent risk ratings and quality of risk management ratings for a plurality of risk categories for a time period;
applying weights, by the computing system, to each of the inherent risk category rating and each of the quality of risk management category rating;
adding the weighted inherent risk category ratings, by the computing system, to yield a composite inherent risk rating;
adding the weighted quality of risk management category ratings, by the computing system, to yield a composite quality of risk management rating; and
displaying, by the computing system, the composite inherent risk rating and the composite quality of risk management rating on a display device.

12. The computer-implemented method of claim 11, wherein the weighted inherent risk rating for each category, the weighted quality of risk management rating for each category, or both, are given by
$$R = ( {\sum }_{1}^{n} {r}_{n} {w}_{n} ) W$$
where n is a number of risk attributes in the category, rₙ is a rating of an n^{th} attribute in the category, wₙ is a weight of the n^{th} attribute, and W is a weight of the inherent risk or the quality of risk management for the category.

13. The computer-implemented method of claim 11, further comprising:
determining a residual risk for each category, by the computing system, by weighting the inherent risk rating and the quality of risk management rating for that category and then adding the weighted inherent risk rating and the quality of risk management rating together.

14. The computer-implemented method of claim 11, further comprising:
weighting, by the computing system, the composite inherent risk rating and the composite quality of risk management rating; and
adding, by the computing system, the weighted composite inherent risk rating and the composite quality of risk management rating to yield a composite residual risk rating.

15. The computer-implemented method of claim 11, further comprising:
determining, by the computing system, average category risk ratings, average composite risk ratings, or both, over multiple time periods.

16. The computer-implemented method of claim 11, further comprising:
reassigning, by the computing system, one or more weights for a risk category for a previous time period.

17. A computer-implemented method, comprising:
determining, by a computing system, inherent risk ratings and quality of risk management ratings for a plurality of risk categories for a current time period;
applying weights, by the computing system, to each inherent risk category rating and each quality of risk management category rating;
adding the weighted inherent risk category ratings, by the computing system, to yield a composite inherent risk rating for the current time period;
adding the weighted quality of risk management category ratings, by the computing system, to yield a composite quality of risk management rating for the current time period;
averaging, by the computing system, the composite inherent risk rating and the composite quality of risk management rating for the current time period with composite inherent risk ratings and composite quality of risk management ratings from a plurality of previous time periods, respectively, to yield an averaged inherent risk rating and an averaged composite quality of risk management rating; and
displaying, by the computing system, the averaged inherent risk rating and an averaged composite quality of risk management rating on a display device.

18. The computer-implemented method of claim 17, wherein the weighted inherent risk rating for each category, the weighted quality of risk management rating for each category, or both, are given by
$$R = ( {\sum }_{1}^{n} {r}_{n} {w}_{n} ) W$$
where n is a number of risk attributes in the category, rₙ is a rating of an n^{th} attribute in the category, wₙ is a weight of the n^{th} attribute, and W is a weight of the inherent risk or the quality of risk management for the category.

19. The computer-implemented method of claim 17, further comprising:
weighting, by the computing system, the composite inherent risk rating for the current time period and the composite quality of risk management rating for the current time period; and
adding, by the computing system, the weighted composite inherent risk rating and the composite quality of risk management rating to yield a composite residual risk rating for the current time period.

20. The computer-implemented method of claim 17, further comprising:
reassigning, by the computing system, one or more weights for a risk category for a previous time period.
